(19) United States
(12) Patent Application Publication
(10) Pub. No.: US 2012/0120887 A1
(43) Pub. Date: May 17, 2012

(54) SYSTEMS, APPARATUSES, AND METHODS TO SUPPORT DYNAMIC SPECTRUM ACCESS IN WIRELESS NETWORKS

(75) Inventors: Juan D. Deaton, Blacksburg, VA (US); Luiz A. DaSilva, Dublin (IE)

(73) Assignee: BATTELLE ENERGY ALLIANCE, LLC, Idaho Falls, ID (US)

(21) Appl. No.: 13/286,434

(22) Filed: Nov. 1, 2011

Related U.S. Application Data
(60) Provisional application No. 61/413,248, filed on Nov. 12, 2010.

(51) Int. Cl. H04W 72/04

(52) U.S. Cl. 370/329

(57) ABSTRACT

A system is disclosed for supporting dynamic spectrum access in wireless networks. The system includes at least one cognitive base station configured to communicate over at least one licensed carrier. The system further includes a spectrum accountability server operably coupled to the at least one cognitive base station. The spectrum accountability server is configured to manage spectrum leases to dynamic spectrum access carriers according to a set of spectrum access rules, and the spectrum accountability server may further be configured to dynamically change the spectrum access rules in response to spectrum usage policies or spectrum availability, or both. A wireless communication network and related method for providing dynamic spectrum access to secondary users of a wireless network are also disclosed herein.

### CROSS-REFERENCE TO RELATED APPLICATION

This application claims the benefit of U.S. Provisional Patent Application Ser. No. 61/413,248, filed Nov. 12, 2010, titled “System, Network, and Method to Support Dynamic Spectrum Access in Wireless Networks,” the disclosure of which is incorporated herein in its entirety by this reference.

### GOVERNMENT RIGHTS

This invention was made with government support under Contract Number DE-AC07-05ID14517 awarded by the United States Department of Energy. The government has certain rights in the invention.

### TECHNICAL FIELD

Embodiments of the present disclosure relate generally to wireless networks and, more specifically, to systems, apparatuses, and methods for supporting dynamic spectrum access in wireless networks.

### BACKGROUND

The next decade is expected to bring accelerated growth in mobile electronic devices and applications, such as those related to smart phone devices. Although accelerated growth in new mobile electronic devices and applications provides a source of revenue for the wireless communications industry, and to wireless network operators, the accelerated growth may be accompanied by an increase in demand for data rates that may soon exceed current spectrum capacity for wireless networks. As a result, wireless network operators have searched for new ways to increase their spectrum capacity.

One option for increasing spectrum capacity is to use unused or underused spectrum opportunistically as a secondary user, such as using the white space spectrum (e.g., vacant TV channels) through methods known as dynamic spectrum access (DSA). By employing a DSA overlay on a wireless network, spectrum capacity-constrained wireless network operators may capture potential revenue by increasing the spectrum capacity for their wireless network through secondary use of additional spectrum. This additional spectrum may be shared among several competing wireless network operators, which may result in interference that detracts from customer satisfaction.

While a DSA overlay may increase spectral capacity for wireless network operators, DSA overlay may also experience significant challenges. One problem of conventional DSA overlay architectures includes unsatisfactory solutions for identifying hidden receivers or identifying users that may violate fair practices in accessing the spectrum as a secondary user, and in turn interfere with other users of the spectrum. For example, spectrum squatters may continuously access the spectrum for a relatively large amount of time in order to prevent other secondary users from using the spectrum.

### BRIEF DESCRIPTION OF THE DRAWINGS

FIG. 1A illustrates a wireless network, such as a modified Long-Term Evolution (LTE) network, according to an embodiment of the present disclosure;

FIG. 1B illustrates a protocol stack for cognitive base station registration and reporting functions to a spectrum accountability server;

FIG. 2A illustrates a simplified wireless communication system with a DSA and spectrum accountability framework according to an embodiment of the present disclosure;

FIG. 2B illustrates protocol stacks for communication between network elements according to an embodiment of the present disclosure;

FIG. 3A illustrates a wireless network architecture, signaling interfaces, and operational procedures for a system that includes a DSA and spectrum accountability framework according to an embodiment of the present disclosure;

FIG. 3B illustrates cooperative sense protocol stacks for communication between different, external networks according to an embodiment of the present disclosure;

FIG. 4 illustrates a cognitive base station carrier channel anatomy according to an embodiment of the present disclosure;

FIG. 5 shows the wireless communication system performing a registration procedure according to an embodiment of the present disclosure;

FIG. 6 shows the wireless communication system performing a cooperative sense procedure according to an embodiment of the present disclosure;

FIG. 7 shows the wireless communication system performing a spectrum lease request procedure according to an embodiment of the present disclosure;

FIG. 8 shows the wireless communication system performing a spectrum lease request procedure between cognitive base stations of different networks according to an embodiment of the present disclosure;

FIG. 9 shows the wireless communication system performing a service request procedure according to an embodiment of the present disclosure;

FIG. 10 shows the wireless communication system performing a new primary operator alert procedure according to an embodiment of the present disclosure;

FIG. 11 shows the wireless communication system performing an integrated receiver interference alarm procedure according to an embodiment of the present disclosure;

FIG. 12 shows the wireless communication system performing a high interference spectrum lease procedure according to an embodiment of the present disclosure;

FIG. 13 shows the wireless communication system performing a rogue transmitter alarm procedure according to an embodiment of the present disclosure;

FIG. 14 shows the wireless communication system performing a spectrum unavailable alarm procedure according to an embodiment of the present disclosure;

FIG. 15 is a wireless network according to an embodiment of the present disclosure that includes cognitive backhaul devices;

FIG. 16 shows the wireless communication system performing a cognitive backhaul device registration procedure according to an embodiment of the present disclosure; and

FIG. 17 shows the wireless communication system performing a cognitive backhaul device spectrum lease procedure according to an embodiment of the present disclosure.

### DETAILED DESCRIPTION

In the following detailed description, reference is made to the accompanying drawings which form a part hereof and in which are shown, by way of illustration, specific embodiments in which the invention may be practiced. In this description, specific implementations are shown and described only as examples and should not be construed as the only way to implement the present invention unless specified otherwise herein. It will be readily apparent to one of ordinary skill in the art that the various embodiments of the present disclosure may be practiced by numerous other partitioning solutions. These embodiments are described in sufficient detail to enable those of ordinary skill in the art to make, use, and otherwise practice the invention, and it is to be understood that other embodiments may be utilized, and that structural, logical, and electrical changes may be made within the scope of the disclosure. For the most part, details concerning timing considerations and the like have been omitted where such details are not necessary to obtain a complete understanding of the present disclosure and are within the abilities of persons of ordinary skill in the relevant art.

Referring in general to the following description and accompanying drawings, various embodiments of the present disclosure are illustrated to show its structure and method of operation. Common elements of the illustrated embodiments may be designated with similar reference numerals. It should be understood that the figures presented are not meant to be illustrative of actual views of any particular portion of the actual structure or method, but are merely idealized representations employed to more clearly and fully depict the features and methodology recited in the claims below.

It will be appreciated and understood by a person of ordinary skill in the art that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

It will be further appreciated and understood by a person of ordinary skill in the art that the various illustrative logical blocks, modules, circuits, and acts described in connection with embodiments disclosed herein may be implemented as electronic hardware, computer software, or combinations of both. To clearly illustrate this interchangeability of hardware and software, various illustrative components, blocks, modules, circuits, and steps are described generally in terms of their functionality. Whether such functionality is implemented as hardware or software depends upon the particular application and design constraints imposed on the overall system. Skilled artisans may implement the described functionality in varying ways for each particular application, but such implementation decisions are not to be interpreted as causing a departure from the scope of the embodiments of the disclosure described herein.

The various illustrative logical blocks, modules, and circuits described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the general-processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

The inventors propose new architectural elements and signaling procedures to support the opportunistic use of spectrum by wireless network operators and their customers. The inventors have also appreciated that because of the possibility of many competitive secondary operators opportunistically using unused or underused spectrum, improved methods and apparatuses for detecting violations of spectrum usage, resolving spectrum feuding, and enforcing judicious spectrum usage may be desirable.

A DSA and spectrum accountability framework for a wireless network is disclosed. The term “primary” operators includes licensed network operators. Primary operators may have primary users that are licensed spectrum users, such as a licensed end user, a licensed base station, etc. The term “secondary” users includes users who do not hold primary licenses to the spectrum but may access it on an opportunistic basis or upon obtaining a secondary lease from the primary user. Competitive secondary users, such as cognitive base stations, may generate and/or process spectrum lease requests using a set of spectrum access rules. A “spectrum lease” may be similar to a spectrum license, but may be dynamically assigned for a more limited access of the spectrum, such as being limited in duration, spectral width, over a specific geographic region, or combinations thereof. A spectrum lease may differ from a spectrum license in other ways in addition, or in the alternative, to those specific differences described herein. A “DSA carrier” refers to a frequency or a set of frequencies (i.e., a portion of spectrum) that is available for a secondary user to use as a communication carrier (i.e., a set of channels) during a spectrum lease. In some embodiments, a single DSA carrier may be supported by a plurality of spectrum leases.

The term “DSA traffic policy” refers to general principles for the wireless network operator to dictate which type of traffic is to be placed on a secondary carrier. An example of a spectrum traffic policy may be a general direction that overflow traffic (i.e., traffic demand that cannot be met using licensed carriers) may be moved to the DSA carriers, if such are available. Another example of a spectrum traffic policy may include keeping priority users on licensed carriers while moving lower priority users onto DSA carriers during overflow situations. Other situations are contemplated in which some types of traffic may be more suited for DSA carriers than for licensed carriers.

The term “spectrum access policy” refers to more general regulation and orders put forth by a regulatory body, such as the Federal Communications Commission (FCC). For example, spectrum access policies may define the conditions by which secondary spectrum users are allowed to use spectrum. An example of a spectrum access policy may be that access to a particular DSA carrier may be dependent on the geographical region of the primary user. For example, the spectrum access policy may be set such that no secondary user can use primary spectrum unless the secondary user lies out of the interference region of the primary user. Another example of a spectrum access policies may be based, at least in part, on a particular requirement regarding spectrum sensing. For example, the spectrum access policy may be set for energy detection and allow use of a DSA carrier as long as the measured energy on the DSA carrier is below a certain threshold.

The term “spectrum access rule” refers to more specific rules which permit a cognitive base station to generate and/or process requests for spectrum leases for use of a secondary spectrum channel. An example of a spectrum access rule may be dependent on the availability of the spectrum based on a query to a geolocation database of primary users, spectrum sensing, and local traffic conditions. A combination of parameters may be used to formulate a lease request which specifies a specific spectrum bandwidth during a specific time period.

Both spectrum access policies and spectrum access rules may be dynamically adjusted by the spectrum access server, if the wireless network operator desires such freedom. Dynamic adjustment of spectrum access rules and policies may be used in order to adjust and increase the spectral capacity based on conditions of the spectral demand, the available DSA carriers, and other changing characteristics of the wireless network. Generally, the spectrum access policies may be distilled into spectrum access rules; however, it is recognized that the line between a spectrum access policy and a spectrum access rule may be difficult to draw, and that such a determination may depend on the preferences of a network operator. As a result, spectrum access policies and spectrum access rules may, at times, be used interchangeably herein.

While embodiments of the present disclosure refer to network elements and protocols that are common to LTE (including LTE Advanced, or LTE+) networks, embodiments should not be viewed as being so limited. Therefore, discussion of an LTE network should be viewed as an example (e.g., a baseline) of how embodiments of the present disclosure may be integrated with existing wireless network elements and protocols. In addition, modifications may be made to other devices and wireless network architectures, such as backhaul devices and Worldwide Interoperability for Microwave Access (WiMax/802.16x) networks, and include the embodiments of the present disclosure. Some embodiments of the present disclosure may include a DSA and spectrum accountability framework of a wireless network that is not integrated with a presently existing wireless network architecture, such as being part of a stand-alone wireless network architecture.

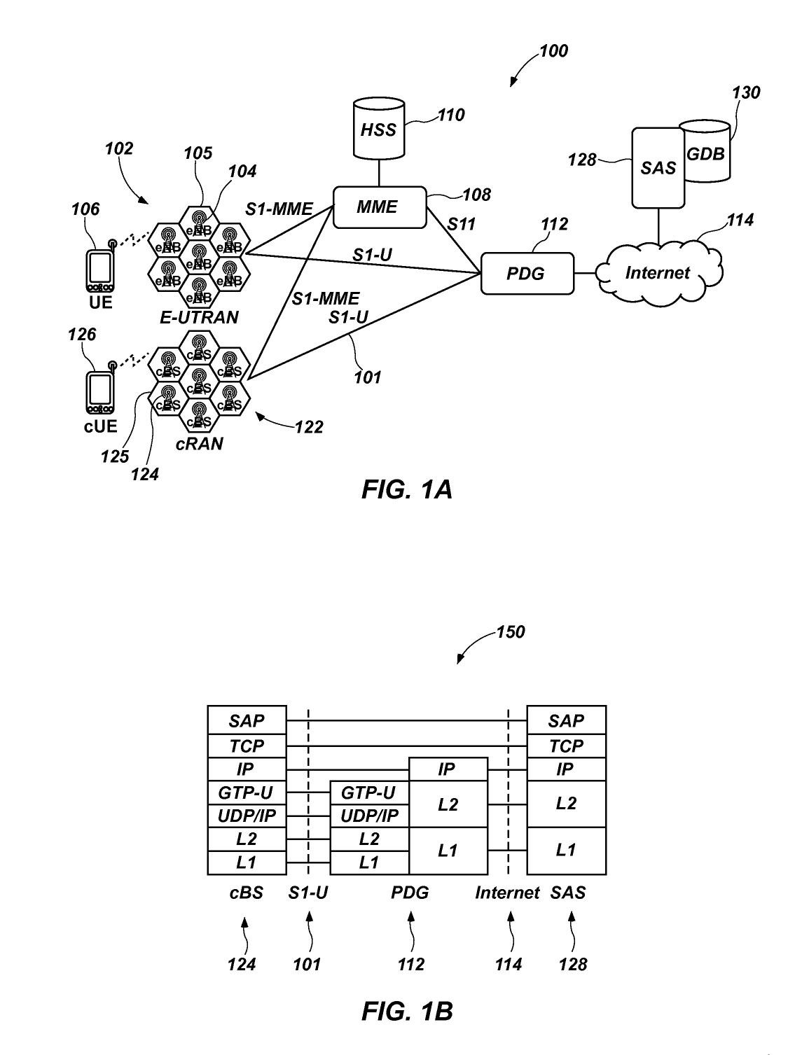

FIG. 1A illustrates a wireless network, such as a modified LTE network 100, according to an embodiment of the present disclosure. Network elements of the modified LTE network 100 that are conventionally included as part of an LTE network include an Evolved Universal Terrestrial Radio Access Network (E-UTRAN) 102, which includes a plurality of evolved Node Bs (eNBs) 104 that couple with user equipment (UE) 106. Each of the plurality of eNBs 104 has an associate coverage area 105 (i.e., cell) in which communication with the user equipment 106 may occur. It is noted that only one of the plurality of eNBs 104 is labeled with its associated coverage area 105, and that the plurality of eNBs 104 includes individual eNBs that have neighboring coverage areas 105 to form a cellular network.

The modified LTE network 100 further includes conventional network elements such as a mobility management entity (MME) 108, a home subscriber service (HSS) 110, and a packet data gateway (PDG) 112. The MME 108 is coupled with the E-UTRAN 102. The MME 108 may be further coupled with the HSS 110. The packet data gateway 112 is coupled to the E-UTRAN 102 and the MME 108.

The user equipment 106 may be an end user for the modified LTE network 100. The user equipment 106 may include electronic devices such as cellular phones, personal digital assistants (PDAs), smart phones, tablets, and other electronic devices that may communicate with the eNBs 104. The plurality of eNBs 104 may operate as base stations for the E-UTRAN 102, in that the user equipment 106 couples to the modified LTE network 100 using the plurality of eNBs 104 through an air interface, where the plurality of eNBs 104 have the function of radio resource control (RRC). In other words, each of the plurality of eNBs 104 is configured for the establishment, configuration, maintenance and release of radio bearers. Conventional LTE networks deploy spectrum segments as carriers on the plurality of eNBs 104. These carriers may support a certain amount of traffic. For example, in an LTE network the smallest carrier size supported may be 1.25 MHz and the LTE network may include a number of resource blocks used for various types of radio bearers.

The MME 108 and the HSS 110 together are configured to perform authentication, authorization, and accounting (AAA) for the modified LTE network 100. The MME 108 employs a signaling protocol called non-access stratum for the user equipment 106 to register for network services and to support encryption. The HSS 110 houses an access database, in a manner similar to a home location register, and includes a record of the user equipment 106 and the corresponding supported service capabilities. In addition to supporting access and security services, the MME 108 is configured to coordinate data bearers for the user equipment 106 through the plurality of eNBs 104 and the packet data gateway 112.

The packet data gateway 112 is configured to couple the user equipment 106 to external packet networks through a network, such as the internet 114. The packet data gateway 112 includes the signaling gateway (SGW) and packet gateway (PGW), each of which may have individual functions. For example, the SGW is configured to route and forward user data packets while also acting as a mobility anchor for the user plane during inter-eNB handoffs and as the anchor for mobility between the modified LTE network 100 and other 3GPP technologies. For user equipment 106 in the idle state (i.e., not connected) the SGW may terminate the downlink data path and trigger paging when downlink data arrives for the user equipment 106. The SGW may further perform replication of the user traffic in case of lawful interception. The PGW is configured to couple the user equipment 106 to external packet data networks by being the point of exit and entry of traffic for the user equipment 106. The PGW may further be configured to anchor the mobility between 3GPP and non-3GPP technologies such as 3GPP2 (CDMA 1X and EvDO) and WiMAX. While the SGW and the PGW may have individual and separate functions, for ease of discussion, the packet data gateway 112 is used to refer to the combined functions of the SGW and the PGW.

The MME 108 may be configured to act as a control-node for the modified LTE network 100. The MME 108 may be responsible for tracking user equipment 106 in the idle state, paging the user equipment 106, and including data re-transmissions to the user equipment 106. The MME 108 may be involved in the radio bearer activation and deactivation processes, and may also be responsible for choosing the SGW for the user equipment 106 at the initial attachment time and at a time of intra-LTE handoff between the plurality of eNBs 104. The MME 108 may further be responsible for authenticating the user equipment 106 by interacting with the HSS 110. The MME 108 may check the authorization of the user equipment 106 and may also enforce the user equipment's 106 roaming restrictions.

While specific functions of the network elements that are conventionally part of an LTE network are described herein, other configurations and functions of these network elements may be present as will be recognized by those of ordinary skill in the art. In addition, modifications to the configurations and functions to these network elements may be present according to the embodiments of the present disclosure. In particular, the modified LTE network 100 may further be configured to support a DSA overlay and spectrum accountability framework. To support the DSA overlay and spectrum accountability framework, the modified LTE network 100 may further include additional network elements, such as a cognitive radio access network (cRAN) 122, a spectrum accountability server (SAS) 128, and a geolocation database (GDB) 130. The cRAN 122 includes a plurality of cognitive base stations (cBS) 124 and cognitive user equipment (cUE) 126.

The cRAN 122 may be coupled to the MME 108 and the PDG 112. The PDG 112 is further coupled to the spectrum accountability server 128 and the geolocation database 142 through a network (e.g., the internet 114). The internet 114 or a private backbone network may include a plurality of routers and switches that are configured to direct communication to the desired destinations. The plurality of cognitive base stations 124 may include most, if not all, of the same functionality of the plurality of eNBs 104, but may further be configured to include additional functionality such as spectrum sensing and traffic trending capabilities to learn and adapt to changing conditions of the modified LTE network 100 and the DSA overlay, as well as interface and communicate with the spectrum accountability server 128, as will be described herein. Likewise, the cognitive user equipment 126 may include most, if not all, of the same functionality of the user equipment 106, but may further be configured to include the additional functionality to learn and adapt to changing conditions of the modified LTE network 100 and the DSA overlay, as well as interface and communicate with the plurality of cognitive base stations 124 and the spectrum accountability server 128, as will be described herein. In other words, the network elements of the E-UTRAN 102 may only be configured to use licensed spectrum, while the network elements associated with the cRAN 122 may use spectrum to which they have a license as well as spectrum to which they do not have a license, but which can be used opportunistically or for which a spectrum lease may be obtained.

The spectrum accountability server 128 is configured to operate within spectrum access policies to coordinate and manage the spectrum leases. The spectrum access policies may be distilled into spectrum access rules, which the plurality of cognitive base stations 124 use to create spectrum lease requests. As will be described herein, the spectrum access policies and the spectrum access rules may be dynamically adjusted and updated by the spectrum accountability server 128 in response to usage and other conditions of the DSA carriers. Additionally, the spectrum accountability server 128 is configured to maintain the geolocation database 130. The geolocation database 130 may store information related to the various network elements of the modified LTE network 100. For example, the geolocation database 130 may include IP addresses of the known primary operators and secondary operators within the modified LTE network 100. The geolocation database 130 may further include geolocation data representing the physical geographical location of the primary and secondary users within the modified LTE network 100. The geolocation database 130 may store information related to the spectrum management of the DSA overlay by maintaining historical spectrum lease information and spectrum usage information.

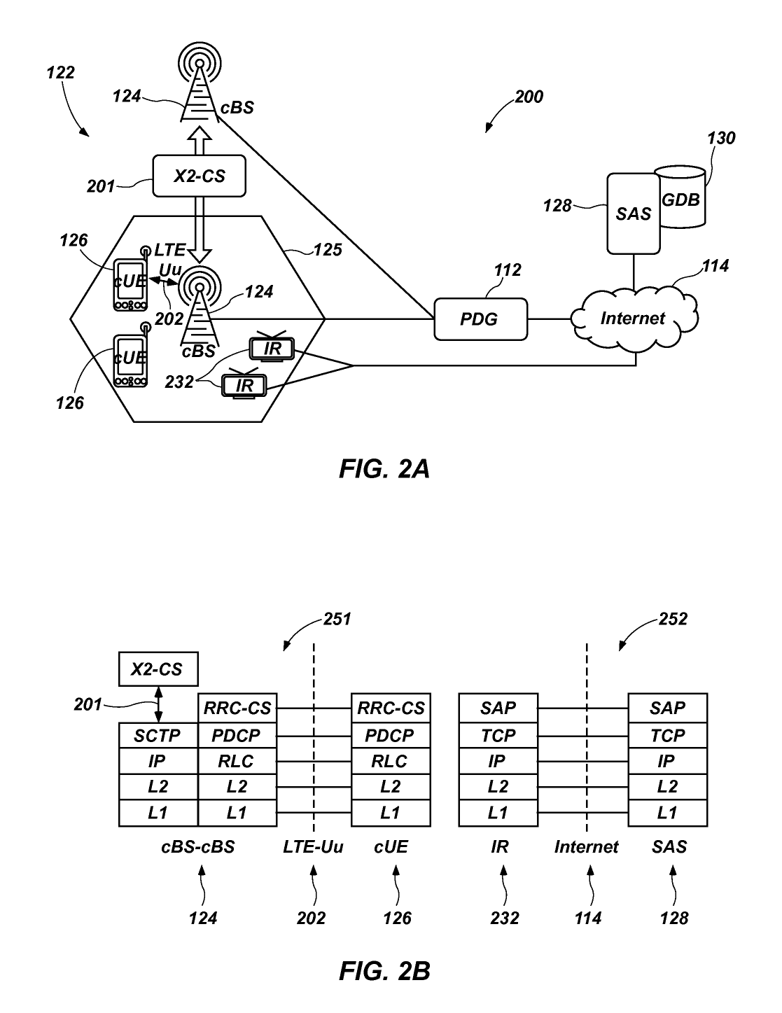

The spectrum accountability server 128 may be configured to perform spectrum management by monitoring spectrum usage metrics received from the cognitive user equipment and the cognitive base station 124. The spectrum accountability server 128 may further perform spectrum management by monitoring alarms received from integrated receivers (IRs) 232A, 232B (FIG. 2A). An integrated receiver 232A, 232B is an IP-connected device within the cRAN 122 that is configured to detect and send interference alarms to the spectrum accountability server 128. For example, the integrated receiver 232A, 232B may be an IP-connected TV or other device with similar functionality.

Thus, the spectrum accountability server 128 is configured to perform functions such as maintaining spectrum leasing policies, coordinating spectrum leases, monitoring spectrum usage during spectrum leases, and managing spectrum access rules. The cognitive base stations 124 may be configured to generate and/or process spectrum lease requests that comply with spectrum access rules according to a determined need for additional spectrum to support a determined demand. The availability of additional spectrum may be determined from cooperative sensing information received from geographic neighbors (i.e., cognitive base stations that are geographically close). Such geographic neighbors may be cognitive base stations that are internal to the home wireless network of the cognitive base station 124. An example of sharing cooperative sensing information among cognitive base stations of the same wireless network will be discussed with respect to FIG. 2A. In some embodiments, cooperative sensing information may be shared among geographic neighbors that are not part of the same wireless network (i.e., cognitive base stations that are part of a different, external, wireless network). An example of sharing cooperative sensing information among cognitive base stations of the same wireless network will be discussed with respect to FIG. 2B.

It is noted that the coverage area 125 of the cRAN 122 may appear to be illustrated in FIG. 1A as being geographically and spatially separate from the coverage area 105 of the E-UTRAN 102. However, the coverage area 105 of the E-UTRAN 102 and the coverage area 125 of the cRAN 122 may partially overlap, or even completely overlap. For example, the modified LTE network 100 may include multiple wireless network operators sharing the same sites to provide wireless services, such as individual eNBs 104 and an individual cognitive base station 124 sharing the same tower or hilltop. In other words, cRAN 122 and E-UTRAN 102 are logically separate and not necessarily physically separate. In some embodiments, the E-UTRAN 102 may not exist, or may not be associated with the DSA overlay, such that the cRAN 122 may operate as a secondary user for unlicensed spectrum, or spectrum that is licensed to another type of network (e.g., another cRAN).

FIG. 1B illustrates a protocol stack 150 for cognitive base station registration and reporting functions to the spectrum accountability server 128. L1 is a physical layer, and L2 is a link layer coupled with the physical layer. UDP/IP are protocols in the transport (UDP) and network (IP) layers. GTP-U and IP protocols are standard protocols for LTE. TCP is a transport layer for LTE. SAP is the spectrum access protocol that is described herein as a protocol for communication between cognitive base stations 124 and the spectrum accountability server 128. In other words, the protocol stack 150 show the different layers that are used by each network element to establish an end to end connection through the different interfaces (e.g., S1-U 101, internet 114). The protocol stack 150 may further show an example for how the spectrum accountability protocol may integrate with the existing LTE architecture.

FIG. 2A illustrates a simplified wireless communication system 200 with a DSA and spectrum accountability framework according to an embodiment of the present disclosure. The wireless communication system 200 includes the cRAN network 122 coupled with the packet data gateway 112, which, in turn, is coupled with the spectrum accountability server 128 and the geolocation database 130. The cRAN 122 includes a plurality of cognitive base stations 124. The cRAN 122 further includes integrated receivers 232 that are coupled with the spectrum accountability server 128 through a network (e.g., internet 114).

Each individual cognitive base station 124 of the plurality has a coverage area 125 for communicating with cognitive user equipment 126. The cognitive user equipment 126 may communicate with an individual cognitive base station 124 over an air interface (e.g., LTE-Uu 202). Within the internal network of the cRAN 122, the plurality of cognitive base stations 124 may communicate with each other through a communication link (e.g., X2-CS 201). For example, the plurality of cognitive base stations 124 within the same internal wireless network may communicate cooperative sensing information with each other.

The plurality of cognitive base stations 124 and the user equipment 126 are configured as previously described with respect to FIG. 1A, in that the plurality of cognitive base stations 124 and cognitive user equipment 126 may be configured to operate on the licensed spectrum of the cRAN network 122, and may operate opportunistically and/or on spectrum for which the plurality of cognitive base stations 124 and cognitive user equipment 126 have a secondary spectrum lease. The cRAN network 122 elements may gain access to the spectrum through spectrum leases allocated by the spectrum accountability server 128, which operates through dynamic spectrum access policies. The spectrum accountability server 128 is further configured to hold the cRAN 122 accountable for the spectrum usage during a spectrum lease through reporting procedures. The spectrum accountability server 128 may also modify spectrum access rules governing the spectrum leases. In some situations, the cRAN 122 may request a spectrum lease directly from the network users holding a license for the spectrum.

FIG. 2B illustrates the protocol stacks 251, 252 for communication between network elements according to an embodiment of the present disclosure. The protocol stack 251 is a cooperative sense protocol stack for communications within a wireless network. The protocol stack 252 is an interference reporting control stack for communications between the integrated receivers 232 and the spectrum accountability server 114. The protocol stack 251 shows layers L1, L2, and IP which are configured as previously described. SCTP is a transmission protocol. X2-CS is a protocol for communication between cognitive base stations 124 within the same wireless network. The cognitive user equipment 126 may have a protocol stack that includes layers L1, L2, RLC, PDCP, and RRC-CS. RLC is a radio link control layer. PDCP is a protocol that performs packet data convergence functions. RRC-CS is a protocol that handles the signaling between the cognitive user equipment and the cognitive base station 124 over an air interface (e.g., LTE-Uu 202). The protocol stack 252 shows that the spectrum accountability protocol may integrate with the protocol stack through TCP/IP for communication over the internet between the integrated receivers 232 and the spectrum accountability server 128. The protocol stacks 251, 252 may further show examples for how the cognitive base station 124, cognitive user equipment 126, integrated receivers 232, and the spectrum accountability server 128 may integrate with the existing LTE architecture.

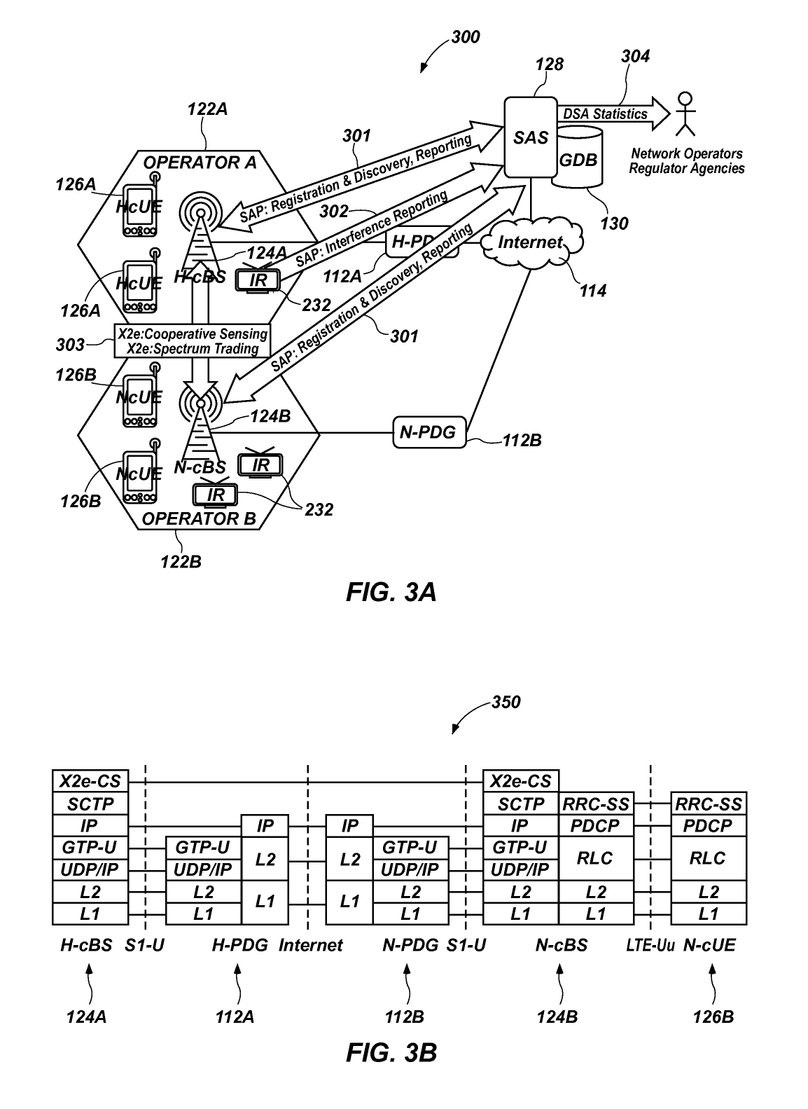

FIG. 3A illustrates a wireless network architecture, signaling interfaces, and operational procedures for a wireless communication system 300 that includes a DSA and spectrum accountability framework according to an embodiment of the present disclosure. The wireless communication system 300 includes a first cRAN 122A and a second cRAN 122B. The first cRAN 122A may have a coverage area for communicating with cognitive user equipment 126A, which coverage area is shown in FIG. 3A as the boundary of the first cRAN 122A. Similarly, the second cRAN 122B may have a coverage area for communicating with cognitive user equipment 126B, which coverage area is shown in FIG. 3A as the cell boundary of the second cRAN 122B.

The first cRAN 122A is labeled as “OPERATOR A,” and the second cRAN 122B is labeled as “OPERATOR B.” OPERATOR A indicates that the first cRAN 122A operates according to a first wireless network operator, while OPERATOR B indicates that the second cRAN 122B operates according to a second wireless network operator. Therefore, it should be clear that, for this example, the first cRAN 122A and the second cRAN 122B are different wireless networks that operate within different licensed spectrum. Therefore, the boundaries of the first cRAN 122A and the second cRAN 122B are intended to illustrate separate licensed spectrum and do not necessarily represent geographic separation. For example, different wireless network operators may include cognitive base stations 124A, 124B that share the same site to provide services to their customers. As a result, portions of the geographic coverage area for the first cRAN 122A and the second cRAN 122B may overlap.

The first cRAN 122A may include a first cognitive base station 124A and at least one integrated receiver (IR) 232A. The second cRAN 122B may include a second cognitive base station 124B and a plurality of integrated receivers 232B. While only one first cognitive base station 124A is illustrated within the first cRAN 122A, it is contemplated that a plurality of first cognitive base stations 124A may be included within the first cRAN 122A. Similarly, while only one second cognitive base station 124B is illustrated within the second cRAN 122B, it is contemplated that a plurality of second cognitive base stations 124B may be included within the second cRAN 122B. As a result, the coverage area for each of the first and second cRAN 122A, 122B, may be subdivided into smaller cells associated with the coverage area for each individual cognitive base station 124A, 124B present in the respective cRAN 122A, 122B. It is further noted that FIG. 3A illustrates a single integrated receiver 232A within the first cRAN 122A, and a plurality of integrated receivers 232B within the second cRAN 122B. Of course, the first cRAN 122A and the second cRAN 122B may include any number of integrated receivers.

For reference purposes, the first cognitive base station 124A may be referred to as a home cognitive base station (H-cBS) 124A, and the second cognitive base station 124B may be referred to as a neighbor cognitive base station (N-cBS) 124B. The cognitive user equipment 126A, 126B within the corresponding coverage areas may be referred to as the home cognitive user equipment (H-cUE) 126A and the neighbor cognitive user equipment (N-cUE) 126B, respectively. The terms “home” and “neighbor” as used herein are merely intended to indicate a particular geographic proximity, and not necessarily to indicate different wireless networks operating in different licensed spectrum, although such a situation may exist such that the coverage areas at least partially overlap.

As an example, FIG. 2A and FIG. 3A are briefly discussed to illustrate this point. In FIG. 2A, the two cognitive base stations 124 shown are part of the same wireless network, and could be considered “neighbors.” Thus, it could be said that one of the cognitive base stations 124 of FIG. 2A is a home cognitive base station, and the other is a neighbor cognitive base station. As discussed above, each of the cognitive base stations 124 may communicate with neighbor cognitive base stations 124 of the same wireless network (i.e., an internal network) through X2-CS communication link. In FIG. 3A, the cognitive base stations 124A, 124B are part of different wireless networks (i.e., external networks). The cognitive base stations 124A, 124B may be geographic neighbors that have different coverage areas, partially overlapping coverage areas, or even substantially the same coverage area (e.g., they may share a site, such as a hilltop, building, etc.). Thus, the first cRAN 122A and the second cRAN 122B may also have coverage areas that overlap despite being shown as separate. Although FIGS. 2A and 3A illustrate a simple case of a single neighbor, many neighbors are also contemplated.

Referring again specifically to FIG. 3A, the first cognitive base station 124A is coupled to a first packet data gateway (H-PDG) 112A, which in turn may be coupled to the spectrum accountability server 128 through a network (e.g., internet 114). Similarly, the second cognitive base station 124B is coupled to a second packet data gateway (N-PDG) 112B, which in turn may be coupled to the spectrum accountability server 128 through a network (e.g., internet 114). As previously discussed above, the spectrum accountability server 128 may be configured to maintain the geolocation database 130. Communication to and from the spectrum accountability server 128 may be supported by a spectrum accountability protocol (SAP). Data transmitted over the SAP may be referred to as SAP data 301, 302.

The first cognitive base station 124A and the second cognitive base station 124B may exchange associated SAP data 301 with the spectrum accountability server 128. It is noted that the arrows shown to represent SAP data 301 may appear to indicate that the first cognitive base station 124A, the second cognitive base station 124B, and the integrated receivers 232 communicate directly with the spectrum accountability server 128. These arrows, however, are intended as showing logical connections between network elements and may, in practice, be transmitted through network elements such as the packet data gateways 112A, 122B.

The SAP data 301 may include data related to registration, neighbor discovery, and reporting for spectrum monitoring for the first and second cognitive base stations 124A, 124B. The registration data may include the geographic physical location of the first and second cognitive base stations 124A, 124B. The registration data may further include IP addresses assigned to each of the cognitive base stations 124A, 124B.

The spectrum accountability server 128 may store the registration data. The registration data may also be transmitted by the spectrum accountability server 128 as SAP data 301 to the various network elements (e.g., the various cognitive base stations 124A, 124B) of the wireless communication system 300 in order to support discovery of neighboring cognitive base stations.

The first and second cognitive base stations 124A, 124B may use the SAP data 301 to report to the spectrum accountability server 128 their use of DSA carriers during a spectrum lease. In particular, the first and second cognitive base stations 124A, 124B may monitor key performance indicators (KPI) including sets of metrics that may be used to monitor the usage of the DSA carriers during a spectrum lease. For example, the KPI may include the number of blocked, lost, and successful service attempts, or other metrics such as block error rates at the first and second cognitive base stations 124A, 124B. Additional KPI metrics may include call detail records and call data logs of service requests that used the DSA carrier, which may correspond to records within the AAA of the MME 108 and the HSS 110 (FIG. 1A).

The integrated receivers 232A, 232B, may transmit SAP data 302 to the spectrum accountability server 128. The SAP data 302 may include data related to interference detected by the integrated receivers 232. With IP connectivity, the integrated receivers 232A, 232B may use SAP data 302 to report interference and other losses of service to the spectrum accountability server 128. As a result, the SAP may form the basis for supporting cooperative sensing, spectrum lease requests, spectrum trading, and spectrum management.

The spectrum accountability server 128 may further be configured to generate DSA statistics 304 and communicate the DSA statistics 304 to interested parties 342, such as network operators, regulating agencies, and other interested parties who may be interested in monitoring spectrum usage during spectrum leases. Monitoring and evaluating the SAP data 301, 302, and DSA statistics 304 may permit the interested parties 342 to monitor secondary users' spectrum usage to ensure that such spectrum usage is performed prudently and in accordance with the rules and laws that may govern such use. As a result, the secondary users may be held accountable for the secondary usage of the spectrum during spectrum leases. The spectrum accountability server 128 may modify spectrum access rules to restrict access by offending parties.

The first cRAN 122A and the second cRAN 122B may also be configured to communicate information therebetween. In other words, cognitive base stations 124A, 124B of different wireless networks (i.e., an external wireless network) may communicate information between them. For example, the first cognitive base station 124A and the second cognitive base station 124B may communicate over a communication link such as the X2e link for transmitting shared data 303 between the first cognitive base station 122A and the second cognitive base station 122B. The shared data 303 may include cooperative sensing data and spectrum trading data. Communication between neighboring cognitive base stations 124A, 124B of an external wireless network may generally occur between geographic neighbors; however, any cognitive base station within the first cRAN 122A may communicate with any cognitive base station within the second cRAN 122B. In order to communicate with cognitive base stations 124A, 124B of an external wireless network or to communicate information between each other, each cognitive base station 124A, 124B may have its own external IP address and a default radio bearer to communicate with the PDG 112A, 112B. In other words, each cognitive base station 124A, 124B may have a radio bearer that serves user traffic between the cognitive base stations 124A, 124B and the PDG 112A, 112B in addition to the radio bearers that serve the user equipment 126A, 126B.

To support signaling to external network entities, each cognitive base station 124A, 124B must register with the MME 108(FIG. 1A) in order for the PDG 112A, 112B to support bearer traffic to external network entities. Through functionality at the PDG 112A, 112B, the IP anchor (i.e., “care of address”) allows external network entities to communicate with the cognitive base stations 124A, 124B within the LTE network. This allows cognitive base stations 124A, 124B to communicate directly, while not residing in the same network. Using an external signaling interface, each cognitive base station 124A, 124B may register with the spectrum accountability server 128 to receive the IP addresses of the other cognitive base stations 124A, 124B. In some embodiments, the cognitive base stations 124A, 124B may only receive information regarding the geographic neighbors of the external wireless network. As previously discussed, each cognitive base station 124, 124B may communicate with the spectrum accountability server 128 to communicate other information such as to issue spectrum lease requests, receive spectrum leases, and report spectrum usage metrics during the spectrum leases.

It is noted that the arrows shown to represent the X2 elink and the shared data 303 may appear to indicate that the first cognitive base station 124A and the second cognitive base stations 124B communicate directly with each other to exchange cooperative sensing and spectrum trading data. In some embodiments, such direct communication may occur. This arrow, however, is intended as showing a logical connection between network elements and may, in practice, be transmitted through network elements such as the packet data gateways 112A and 112B.

FIG. 3B illustrates cooperative sense protocol stacks 350 for communication between different, external networks according to an embodiment of the present disclosure. The different layers and protocol in the protocol stacks of FIG. 3B are configured similarly to those described in FIGS. 1B and 2B. For the first cognitive base station 124A to communicate with the second cognitive base station 124B, communication may be performed according to the different protocol stacks between the home packet data gateway 112A and the neighbor packet data gateway 112B. X2e-CS is the application protocol for communication between the first cognitive base station 124A and the second cognitive base station 124B. X2e-CS is similar to the X2-CS protocol described in FIGS. 2A and 2B, with the “e” identifier indicating that the communication occurs with an external network operating in a different spectrum rather than communicating within the same internal network as X2-CS was described in FIGS. 2A and 2B. The protocol stack 350 may further show an example of how the communication between different wireless network operators may integrate with the existing LTE architecture.

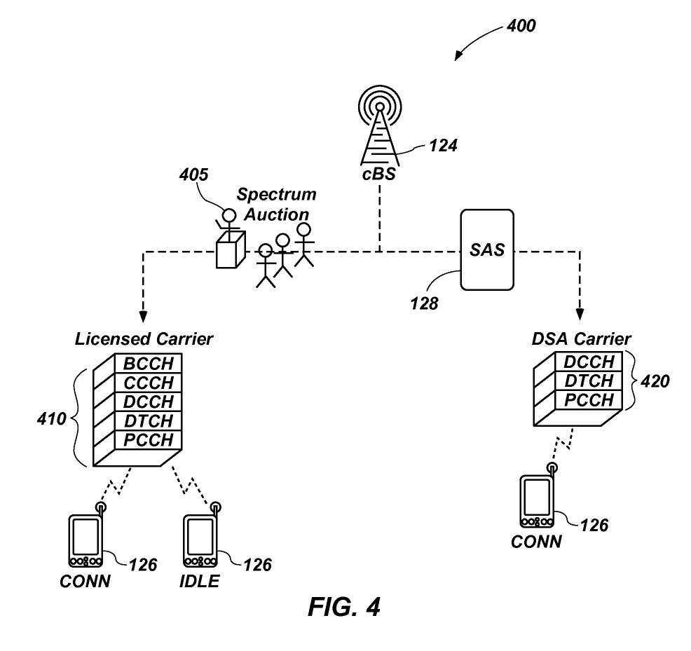

FIG. 4 illustrates a cognitive base station carrier channel anatomy 400 according to an embodiment of the present disclosure. In particular, a cognitive base station 124 may communicate with the cognitive user equipment 126 using the wireless network operators' licensed frequencies over a licensed carrier 410. The cognitive base station 124 may also communicate with cognitive user equipment 126 using the DSA carrier 420. For example, connected cognitive user equipment (CONN) 126 and idle cognitive user equipment (IDLE) 126 may communicate over the licensed carrier 410 and operate at a frequency in the licensed spectrum of the cognitive base station 124 according to spectrum auctions 405. The spectrum auction 405 is a process known in the art for spectrum to be assigned to a licensed carrier 410.

The licensed carrier 410 includes a plurality of control channels for the connected cognitive user equipment (CONN) 126 and idle cognitive user equipment (IDLE) 126 to communicate with the cognitive base station 124. For example, the broadcast control channel (BCCH) and the common control channel (CCCH) may permit the idle cognitive user equipment (IDLE) 126 to make an RRC connection request through initialization, synchronization, and random access to the wireless network. Other LTE standard bearer channels may be supported by the licensed carrier, including the dedicated control channel (DCCH), the dedicated traffic channel (DTCH), and the paging control channel (PCCH).

The DSA carrier 420 operates at a frequency that may not be in the licensed spectrum of the cognitive base station 124. As a result, the cognitive base station 124 may have requested and received a spectrum lease as governed by the spectrum accountability server 128, as is described herein. When a spectrum lease has been granted to the cognitive base station 124, the idle cognitive user equipment (IDLE) 126 may connect with the cognitive base station 124 and communicate with the cognitive base station 124 over the DSA carrier 420 associated with the spectrum lease.

The DSA carrier 420 includes a plurality of control channels for the connected cognitive user equipment (CONN) 126 to communicate with the cognitive base station 124. For example, DSA carrier 420 may support the DCCH, the DTCH, and the PCCH, each of which may be configured similarly as in the licensed carrier 410. The BCCH and the CCCH may not be supported by the DSA carrier 420. As a result, the idle cognitive user equipment (IDLE) 126 may request service to the cognitive base station 124 through a licensed carrier 410. After the idle cognitive user equipment (IDLE) 126 becomes connected to the cognitive base station 124 through the licensed carrier 410, the now-connected cognitive user equipment (previously IDLE) 126 may be transferred to a DSA carrier 420 through a carrier handoff procedure. Any currently connected cognitive user equipment (CONN) 126 may be transferred to a DSA carrier 420 during a spectrum lease. For example, the licensed carrier 410 may lack sufficient capacity, and the cognitive base station 124 may request and receive a spectrum lease as governed by the spectrum accountability server 128, as is described herein. If a spectrum lease has been granted to the cognitive base station 124, the connected cognitive user equipment (CONN) 126 may connect with the cognitive base station 142 and communicate with the cognitive base station 124 over the DSA carrier 420 associated with the spectrum lease. In other words, the licensed carrier 410 may bootstrap the DSA carrier 420 for tasks like cognitive user equipment synchronization and access, while the DSA carrier 420 may be used to increase the cognitive base station operating capacity by adding more traffic channels.

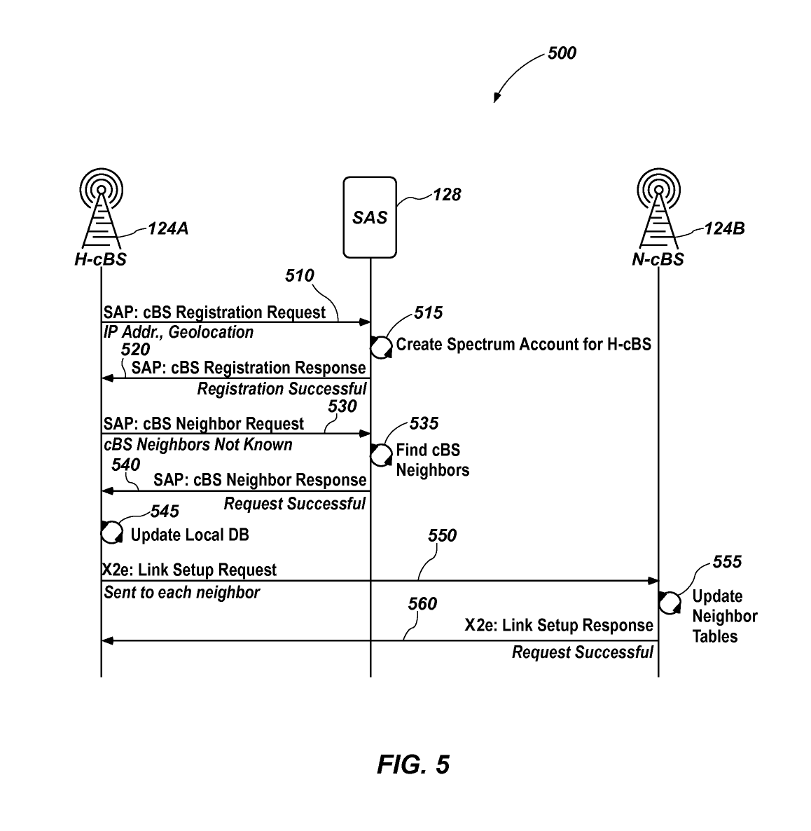

FIG. 5 is a simplified wireless communication system including a DSA and spectrum accountability framework. In particular, FIG. 5 shows the wireless communication system performing a registration procedure 500 according to an embodiment of the present disclosure. The registration procedure 500 includes a method for registering the cognitive base station 124A, discovering the second cognitive base station 124B, and linking neighboring cognitive base stations 124A, 124B according to an embodiment of the present disclosure.

The wireless communication system includes a first cognitive base station 124A, a spectrum accountability server 128, and second cognitive base station 124B. As previously discussed, the first cognitive base station 124A may be part of a first cRAN 122A (FIG. 3A) that may include a plurality of cognitive base stations operating with a first set of frequency bands as its primary spectrum. The second cognitive base station 124B may be a part of the second cRAN 122B (FIG. 3A) that may include a plurality of cognitive base stations operating with a second set of frequency bands as its primary spectrum. As previously discussed, for reference purposes, the first cognitive base station 124A may be referred to as the home cognitive base station (H-cBS) 124A, and the second cognitive base station 124B may be referred to as the neighbor cognitive base station (N-cBS) 124B.

Prior to the operations shown in FIG. 5, the first cognitive base station 124A may not be registered with the spectrum accountability server 128. At operation 510, the first cognitive base station 124A may transmit a registration request to the spectrum accountability server 128. The registration request may include SAP data 301, which may include registration data. The registration data may include information related to the geographic physical location of the first cognitive base station 124A, an IP address assigned to the first cognitive base station 124A, other identifying data, and combinations thereof At operation 515, the spectrum accountability server 128 receives the registration data, and creates a spectrum account by updating the geolocation database 130 (FIG. 1A). At operation 520, the spectrum accountability server 128 transmits a registration response signal to the first cognitive base station 124A indicating that the registration is successful. Once registration of the first cognitive base station 124A is performed to open a spectrum account with the spectrum accountability server 128, other procedures may be performed, such as validating spectrum lease requests, discovering neighbor cognitive base stations 124B that also have spectrum accounts with the spectrum accountability server 128, establishing communication links (e.g., X2 elinks) with neighbor cognitive base stations 124B, and obtaining the spectrum access rules.

For example, discovery of neighboring cognitive bases stations may be performed. At operation 530, the first cognitive base station 124A may not be aware of the second cognitive base station 124B, and the first cognitive base station 124A may transmit a neighbor request signal to the spectrum accountability server 128. At operation 535, the spectrum accountability server 128 may query the geolocation database 130 in order to find identifying information (e.g., geolocation information, IP addresses, etc.) for the second cognitive base station 124B. At operation 540, the spectrum accountability server 128 transmits the identifying information to the first cognitive base station 124A to complete the successful neighbor request. At operation 545, the first cognitive base station 124A may update a local database (not shown) with the identifying information for the second cognitive base station 124B. As a result, the first cognitive base station 124A may not be required to communicate with the spectrum accountability server 128 to reacquire the identifying information for the second cognitive base station 124B.

With knowledge of the second cognitive base station 124B of the second cRAN 122B (FIG. 3A), the first cognitive base station 124A may desire to communicate with the second cognitive base station 124B, such as to initiate cooperative sensing or spectrum trading procedures. At operation 550, a communication link may be initiated between the first cognitive base station 124A and the second cognitive base station 124B. In particular, a communication link set up request may be transmitted from the first cognitive base station 124A to the second cognitive base station 124B. If more than one second cognitive base station 124B of the second cRAN 122B has been identified, then a communication link set up request may be transmitted to a plurality of second cognitive base stations 124B.

At operation 555, the second cognitive base station 124B may update a local database (not shown) with identifying information for the cognitive base station 124A received during the communication link set up request in order for the second cognitive base station 124B to have a local record of the first cognitive base stations 124A of the first cRAN. At operation 560, the second cognitive base station 124B may transmit a link set up response signal to the first cognitive base station 124A with data indicating that the link set up request is successful and that the communication link is established. The communication link may be any type of communication link, including, for example, an X2e communication link. With the communication link established between the first cognitive base station 124A and the second cognitive base station 124B, data may be transmitted therebetween. For example, cooperative sensing data, spectrum trading data, and other data may be transmitted therebetween as will be described herein.

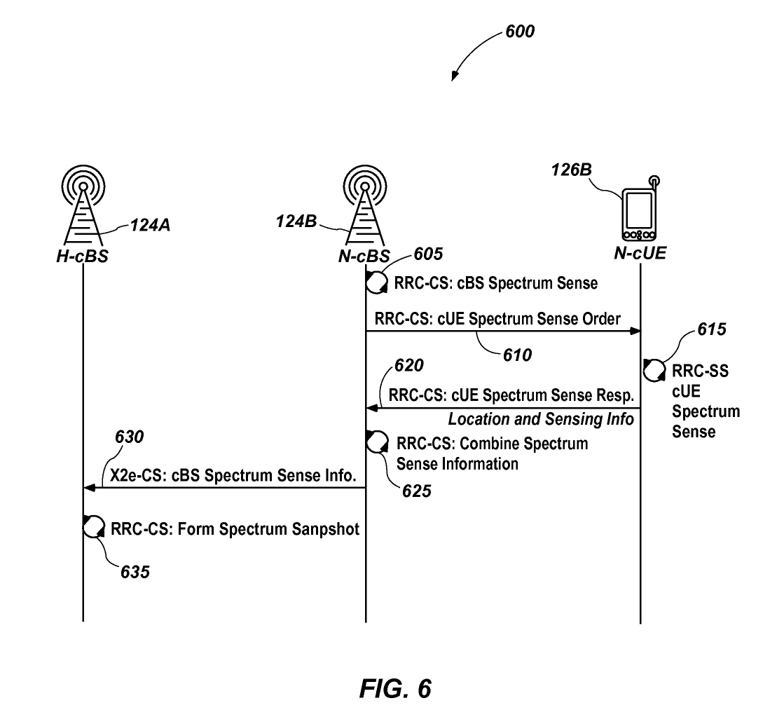

FIG. 6 is a simplified wireless communication system including a DSA and spectrum accountability framework. In particular, FIG. 6 shows the wireless communication system performing a cooperative sense procedure 600 according to an embodiment of the present disclosure. Prior to a cooperative sense procedure 600, a communication link may be established between the first cognitive base station 124A of the first cRAN 122A (FIG. 3A) and the second cognitive base station 124B of the second cRAN 122B (FIG. 3A). An example of establishing the communication link is described with reference to FIG. 5. The second cognitive base station 124B may have a second cognitive user equipment (N-cUE) 126B within its coverage area.

At operation 605, the second cognitive base station 124B performs spectrum sensing and collects spectrum sensing information. Spectrum sensing functions may be performed by radio resource control (RRC). For example, spectrum sensing may include energy detection for a particular spectral bandwidth, cyclostationary sensing, and other methods that may be used to derive information about the current status of the spectrum of interest.

At operation 610, the second cognitive base station 124B transmits a spectrum sense order to the second cognitive user equipment 126B for the second cognitive user equipment 126B to collect spectrum sensing information in its area of operation. When the second cognitive user equipment 126B has completed the spectrum sensing at operation 615, the second spectrum sensing information is transmitted to the second cognitive base station 124B as a spectrum sensing response at operation 620. At operation 625, the second cognitive base station 124B combines the sensing information received from the second cognitive user equipment 126B with the spectrum sensing information collected during operation 605.

At operation 630, the combined spectrum sensing information is transmitted to the first cognitive base station 124A. At operation 630, the first cognitive base station 124A receives the combined spectrum sensing information and updates a local spectrum sensing database (not shown) to form a spectrum snapshot at operation 635. The combined sensing information for the cognitive base stations 124B and the cognitive user equipment 126B may be termed a “spectrum snapshot.” Thus, the spectrum snapshot may include spectrum sensing information from one or more cognitive base station 124B in a network, one or more cognitive user equipment 126B, or a combination thereof Having spectrum sensing information from both the cognitive base stations 124B and the cognitive user equipment 126B may be desirable as multiple sensing locations and different perspectives may be provided. Such a sharing of spectrum sensing information may occur on-demand by one or more of the cognitive base stations 124A, 124B, or may be set to occur periodically according to a desired schedule. The cooperative sensing data may be used for determining spectrum leases, and for making DSA carriers available for the secondary users to the wireless network.

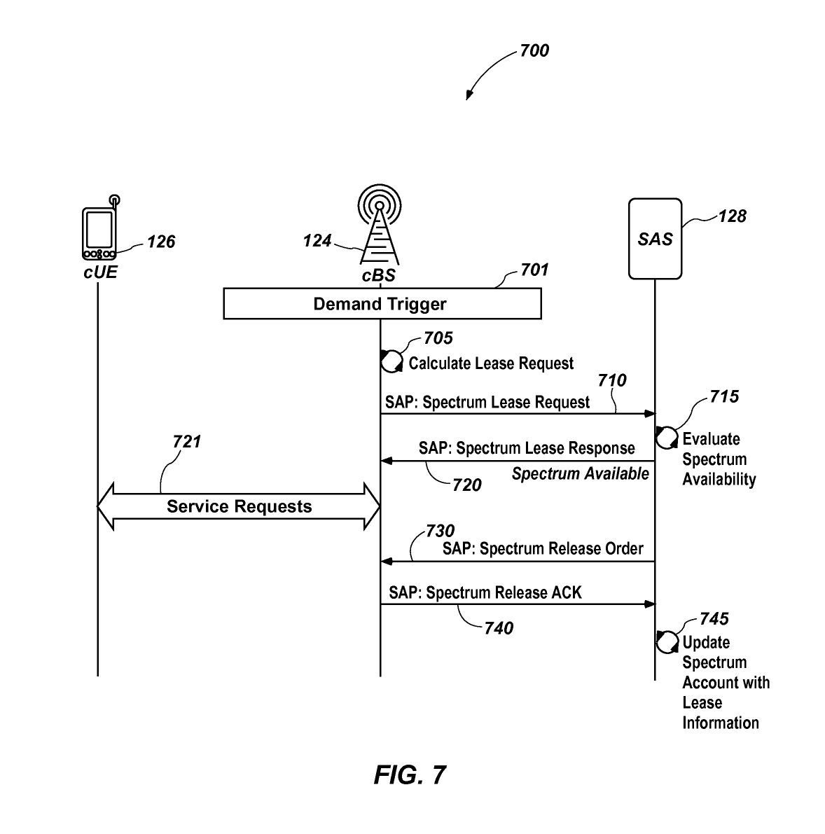

FIG. 7 is a simplified wireless communication system including a DSA and spectrum accountability framework. In particular, FIG. 7 shows the wireless communication system performing a spectrum lease request procedure 700 according to an embodiment of the present disclosure. The spectrum lease request procedure 700 may occur at times when augmenting the spectral capacity available for the cognitive user equipment 126 may be desirable. At operation 701, the spectrum lease request procedure 700 may be set to be initiated by the cognitive base station 124 according to a predetermined “demand trigger.” In some embodiments, the cognitive base station 124 may be triggered to transmit a spectrum lease request signal to the spectrum accountability server 128 in response to an increase in traffic on the modified LTE network 100 (FIG. 1A). In some embodiments, the demand trigger may also be set to occur automatically for a predetermined event. For example, there may be a time of day (e.g., during rush hour) when it is anticipated that an increase in spectrum capacity may be needed. Such a determination may be made based on an analysis of the spectrum usage metrics recognizing historical trends in the daily usage of the primary spectrum. A demand trigger may be set at a particular time when a unique event may occur (e.g., a sporting event) when it is anticipated that an increase in spectral capacity may be needed. A demand trigger may further be determined by a predictive algorithm that analyzes historical data to predict future spectrum needs of a network. Therefore, the demand trigger may be responsive to real-time increases in spectral usage, as well as automatically and prospectively based on anticipated demand before the actual increase in demand occurs. Demand triggers may also be initiated by the cognitive user equipment 126, in addition to solely by the cognitive base stations 124. As one such example, a demand trigger may be based on a cognitive user equipment 126 connecting to the wireless network, on handoffs of the cognitive user equipment 126, or some other cognitive user equipment 126 initiated event.

At operation 705, the cognitive base station 124 calculates the parameters of the spectrum lease request based at least in part on the traffic load and spectrum statistics collected from the cooperative sense procedure 600 (FIG. 6) as part of the spectrum snapshot. Calculating the parameters of the spectrum lease request may include calculating the present spectral demand and determining the amount of spectrum needed to accommodate present demand. The parameters of the spectrum lease request may include, for example, desired DSA carriers, desired bandwidth, a desired duration of the spectrum lease request, other parameters, and combinations thereof.

At operation 710, the cognitive base station 124 may transmit a spectrum lease request signal to the spectrum accountability server 128 indicating the desired parameters. At operation 715, the spectrum accountability server 128 may evaluate the spectrum lease request based, at least in part, on the current spectrum access policy and the current spectrum access rules. When the spectrum lease request has been evaluated, the spectrum accountability server 128 may send a spectrum lease response to the cognitive base station 124 at operation 720. The spectrum lease response may indicate whether or not the spectrum accountability server 128 elected to validate or invalidate the spectrum lease request. In one example, the spectrum lease request may be considered valid if there is sufficient spectrum available for a secondary user, and if the cognitive base station 124 is following spectrum access rules. At this point, the cognitive base station 124 may operate according to the parameters of the spectrum lease when fielding service requests.

At operation 721, the cognitive user equipment 126 may issue a service request to the cognitive base station 124. For example, the cognitive user equipment 126 may be a primary user for the cognitive base station 124 of a cRAN network (FIG. 1A). Because of the increased demand on the primary network, it may be desirable for the cognitive base station 124 to service this request by using secondary spectrum on another network. Because the cognitive base station 124 has been informed that a spectrum lease is available, the cognitive base station 124 may handle the service request by connecting the cognitive user equipment 126 as a secondary user of the spectrum of another network. During the time that the spectrum lease is available to the cognitive base station 124, one or more service requests may have been placed by different cognitive user equipment 126. In other words, the duration of the spectrum lease may be independent of the duration of the service request by the individual cognitive user equipment 126.

At operation 730, the spectrum accountability server 128 may terminate the spectrum lease granted to the cognitive base station 124 by transmitting a spectrum release order to the cognitive base station 124. For example, the spectrum release order may occur after the time period of the lease has expired, or upon occurrence of some other event. At operation 740, the cognitive base station 124 may respond and transmit a spectrum release acknowledgment (ACK) to the spectrum accountability server 128. In the spectrum release acknowledgment, the cognitive base station 124 may further provide the spectrum usage metrics of the cognitive base station 124 for the service requests using the spectrum as a secondary user during the spectrum lease. In some embodiments, spectrum usage metrics may be sent separately from the spectrum release acknowledgment.

With the spectrum usage metrics, the spectrum accountability server 128 may monitor the spectrum usage of the cognitive base stations 124 during the spectrum lease. Spectrum usage metrics may include the number, frequency, and types of service requests, throughput, and other metrics associated with the usage of the DSA carriers during the spectrum lease. Other information may be included as well. At operation 745, the spectrum accountability server 128 may update the spectrum account for the requesting cognitive base station 124 with a record that the cognitive base station 124 used the spectrum lease, along with its spectrum usage metrics. The spectrum accounts for each cognitive base station 124 with spectrum lease records may be stored within the geolocation database (FIG. 1A), or in another separate database managed by the spectrum accountability server 128.

The spectrum lease request procedure 700 describes a simple situation where calculating the parameters of the spectrum lease request in operation 710 includes calculating the present spectral demand and determining the amount of spectrum needed to accommodate present demand. Calculating the parameters of the spectral lease request may include the cognitive base station 124 calculating the amount of bandwidth that is predicted (e.g., using predictive algorithms) to accommodate future load and determine DSA carriers for use in the spectrum lease request. It is further contemplated that the cognitive base station 124 may be configured to predict (e.g., through machine learning methods) spectral conditions (e.g., future traffic patterns) to determine the spectrum lease expectations. Additional embodiments may include automatic spectrum lease renewals, or automatic changes to existing spectrum lease requests. For example, automatic spectrum lease renewals may be used to support predicable periodic load increases on the network, such as increases in spectral demand on cognitive base stations 124 located on a roadside that experiences a relatively large volume of commuter traffic during certain hours. In another embodiment, calculation of parameters for spectrum lease requests may occur as a sub-procedure negotiation, wherein the cognitive base station 124 and spectrum accountability server 128 exchange information of needs and spectrum lease availability. Another embodiment may include calculating parameters of the spectrum lease request even when demand is not exceeding a threshold, but as part of an optimization task, such as when requested on-demand or during an off-peak hour when cognitive base station 124 resources are available for performing the optimization tasks.

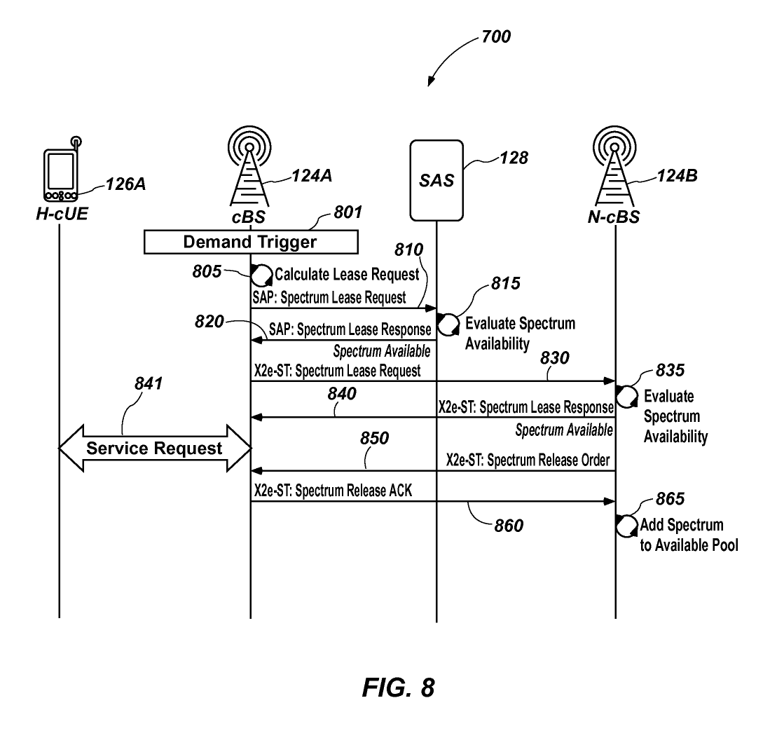

FIG. 8 is a simplified wireless communication system including a DSA and spectrum accountability framework. In particular, FIG. 8 shows the wireless communication system performing a spectrum lease request procedure 800 between cognitive base stations of different networks according to an embodiment of the present disclosure. At operation 801, the spectrum lease request procedure 800 may be set to be initiated by a first cognitive base station 124A according to a predetermined “demand trigger.” Examples of demand triggers are described with respect to operation 701 of FIG. 7. At operation 805, the first cognitive base station 124A may calculate the parameters of the spectrum lease request based at least in part on the traffic load and spectrum statistics collected from the cooperative sense procedure 600 (FIG. 6). At operation 810, the first cognitive base station 124A may transmit a spectrum lease request signal to the spectrum accountability server 128 indicating the desired parameters of the spectrum lease request. Desired parameters may include desired DSA carriers, desired bandwidth, a desired period of the spectrum lease request, and combinations thereof. At operation 815, the spectrum accountability server 128 may evaluate the spectrum lease request based, at least in part, on the spectrum access policies governing the spectrum leasing. Therefore, operations 801, 805, 810, and 815 may be similar to the operations 701, 705, 710, and 715 of the lease request procedure 700 shown in FIG. 7.

When the spectrum lease request has been evaluated, the spectrum accountability server 128 may determine that the desired spectrum for the spectrum lease request is unavailable, or otherwise invalid. For example, the spectrum access rules may not permit the spectrum accountability server 128 to authorize usage of the spectrum requested. At operation 820, the spectrum accountability server 128 may transmit a spectrum lease response signal to the first cognitive base station 124A indicating that the desired spectrum for the spectrum lease request is unavailable, or the spectrum lease request is otherwise invalid. As a result, the first cognitive base station 124A may not become a secondary user for the spectrum available and governed by the spectrum accountability server 128.

The first cognitive base station 124A may further inquire with a second cognitive base station 124B of a different network to determine whether there is a spectrum lease available for the spectrum used by the second cognitive base station 124B. In other words, the first cognitive base station 124A may desire to become a secondary user for the unused or underused spectrum of the second cognitive base station 124B. The unused or underused spectrum of the second cognitive base station 124B may include the licensed spectrum of the second cognitive base station 124B. In some embodiments, the unused or underused spectrum of the second cognitive base station 124B may be part of a spectrum lease that has been granted to the second cognitive base station 124B that is available. In other words, the second cognitive base station 124B may be permitted to sub-lease a spectrum lease to the first cognitive base station 124A.

At operation 830, the first cognitive base station 124A transmits a spectrum lease request to the second cognitive base station 124B of a different network. At operation 835, the second cognitive base station 124B evaluates the spectrum lease request. For example, the second cognitive base station 124B may examine the current valid spectrum leases within the first cognitive base station's 124A geographic area. At operation 840, the second cognitive base station 124B determines that there is spectrum available to grant a spectrum lease to the first cognitive base station 124A. The second cognitive base station 124B transmits a spectrum lease response to the first cognitive base station 124A indicating that spectrum is available for the desired spectrum lease. At this point, the first cognitive base station 124A may operate according to the parameters of the spectrum lease when fielding service requests.

At operation 841, a cognitive user equipment (H-cUE) 126A within the network of the first cognitive base station 124A may issue a service request to the first cognitive base station 124A. Because of the increased demand on the primary network of the first cognitive base station 124A, it may be desirable for the first cognitive base station 124A to service this service request using the spectrum of another network as a secondary user. Because the first cognitive base station 124A has been informed that a spectrum lease is available from the second cognitive base station 124B, the first cognitive base station 124A may handle the service request by connecting the cognitive user equipment 126A as a secondary user of the spectrum of the second cognitive base station 124B. During the time that the spectrum lease is available to the first cognitive base station 124A, one or more service requests may have been placed by one or more different cognitive user equipment 126A.

At operation 850, the second cognitive base station 124B may terminate the spectrum lease granted to the first cognitive base station 124A by transmitting a spectrum release order to the first cognitive base station 124A. For example, the spectrum release order may occur after the time period of the lease has expired, or upon occurrence of some other event. At operation 860, the first cognitive base station 124A may respond and transmit a spectrum release acknowledgment (ACK) to the second cognitive base station 124B. The spectrum acknowledgment (ACK) may include spectrum usage metrics for the service requests during the spectrum lease period. The second cognitive base station 124B may receive and store information related to the monitoring of the spectrum usage during the spectrum lease. At operation 865, the second cognitive base station 124B adds the spectrum from the terminated spectrum lease back into the second cognitive base station's 124B available pool of spectrum for its primary operators or for future spectrum leases to secondary users. For embodiments in which the second cognitive base station 124B provided a sub-lease of its spectrum lease, the second cognitive base station 124B may further provide the spectrum usage metrics from the first cognitive base station 124A to the spectrum accountability server 128. In some embodiments, the first cognitive base station 124A may provide the spectrum usage metrics to the spectrum accountability server 128 directly.

Therefore, FIG. 7 illustrates that the cognitive base station 124 may obtain a spectrum lease from the spectrum accountability server 128, while FIG. 8 illustrates that the first cognitive base station 124A may obtain a spectrum lease from a second cognitive base station 124B of a different network. Although FIG. 8 describes that the spectrum lease is obtained from the second cognitive base station 124B after first attempting to obtain a spectrum lease from the spectrum accountability server 128, embodiments of the present disclosure may not to be so limited. For example, in some embodiments, the first cognitive base station 124A may first attempt to obtain a spectrum lease from the second cognitive base station 124B before attempting to obtain a spectrum lease from the spectrum accountability server 128, if at all. In some embodiments, the first cognitive base station 124A may obtain spectrum leases through both the spectrum accountability server 128 and the second cognitive base station 124B.

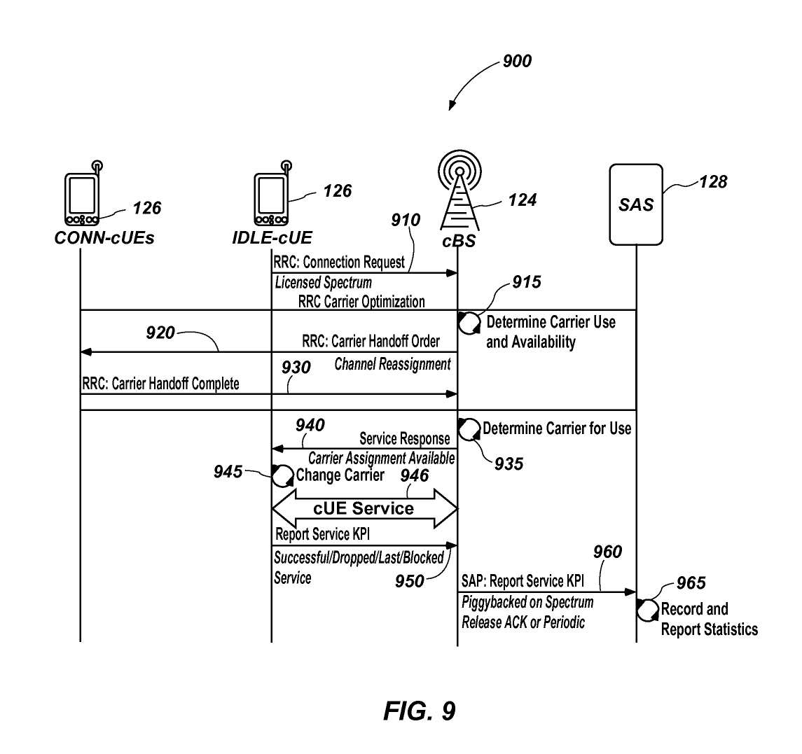

FIG. 9 is a simplified wireless communication system including a DSA and spectrum accountability framework. In particular, FIG. 9 shows the wireless communication system performing a service request procedure 900 according to an embodiment of the present disclosure. It is assumed that for the service request procedure 900 of FIG. 9 a spectrum lease has been granted to the cognitive base station 124 and that the DSA carrier is in use by the cognitive base station 124. For example, the spectrum lease may have been granted by the spectrum accountability server 128 (FIG. 7), or by another cognitive base station of another network (FIG. 8). It is also assumed that prior to the service request procedure 900, a connected cognitive user equipment (CONN-cUE) 126 is in communication over the primary spectrum of the cognitive base station, and an idle cognitive user equipment (IDLE-cUE) 126 has not yet connected for communication.

At operation 910, the idle cognitive user equipment (IDLE-cUE) 126 transmits a connection request signal to the cognitive base station 124, which is a primary operator on a licensed carrier signal. In other words, the idle cognitive user equipment (IDLE-cUE) 126 may be a primary operator with the cognitive base station 124 on a wireless network. The wireless network may have a wireless network operator that governs the communication on the wireless network.

The wireless network operator may have its own spectrum traffic policy for directing traffic to a specific carrier type. The spectrum traffic policy of the wireless network operator may determine what actions are taken related to the connected cognitive user equipment (CONN-cUE) 126 on the licensed channels of its wireless network.

For example, the spectrum traffic policy may place all overflow from licensed carriers onto the DSA carrier. Another policy may be to have preferred licensed user equipment 126 that may not be handed off to the DSA carriers. As a result, non-preferred licensed user equipment 126 may be transferred to the DSA channel, while a preferred licensed user equipment may be connected to the licensed carriers.

If it is determined by the cognitive base station 124 that one or more connected cognitive user equipment (CONN-cUEs) 126 is to be sent to the DSA carriers as a secondary user of another network, the cognitive base station 124 may initiate a carrier handoff procedure. At operation 915, the carrier use and carrier availability are determined. If it is determined that a secondary carrier is available, at operation 920, the cognitive base station 124 transmits a carrier handoff order to the affected connected cognitive user equipment (CONN-cUEs) 126 in order to reassign the channel used by the connected cognitive user equipment (CONN-cUEs) 126. At operation 930, the connected cognitive user equipment (CONN-cUEs) 126 transmits a signal to the cognitive base station 124 indicating that the carrier handoff for the connected cognitive user equipment (CONN-cUEs) is complete. At that point, the connected user equipment (CONN-cUE) 126 communicates as a secondary user on the spectrum according to the terms of the spectrum lease.

At operation 935, the cognitive base station 124 determines the appropriate carrier for the idle cognitive user equipment (IDLE-cUE) 126 to use. At operation 940, the cognitive base station 124 transmits a service response to the idle cognitive user equipment (IDLE-cUE) 126 indicating the carrier assignment that is available. The carrier assignment may be a DSA carrier of another network that is part of a spectrum lease permitting the cognitive base station 124 to provide service to secondary users of the network for the spectrum lease. In some embodiments, the cognitive base station 124 may provide service to the idle cognitive user equipment (IDLE-cUE) 126 as a primary user of its licensed spectrum. At operation 945, the carrier used for communication may be changed, and at operation 946, service is provided to the idle cognitive user equipment (IDLE-cUE) 126. Thus, the idle cognitive user equipment (IDLE-cUE) 126 becomes connected through cognitive user equipment service, and the idle cognitive user equipment (IDLE-cUE) 126 communicates within the appropriate carrier.

After or during service, spectrum usage metrics (e.g., KPI) may be collected from the cognitive user equipment 126 at operation 950 for the idle cognitive user equipment (IDLE-cUEs) 126 (which is technically no longer idle during service). At operation 960, the cognitive base station 124 forwards the spectrum usage metrics to the spectrum accountability server 128, which may be accomplished via individual messaging or piggybacked onto the spectrum release acknowledgment (ACK). Individual messaging of the spectrum usage metrics may occur on demand, periodically, or according to another time interval, as desired. At operation 965, the spectrum accountability server 128 may record and report the spectrum usage metrics into the geolocation database (FIG. 1A), or some other database managed by the spectrum accountability server 128. Spectrum usage metrics may be sent to interested parties 342 (FIG. 3A) for monitoring and accountability measures.

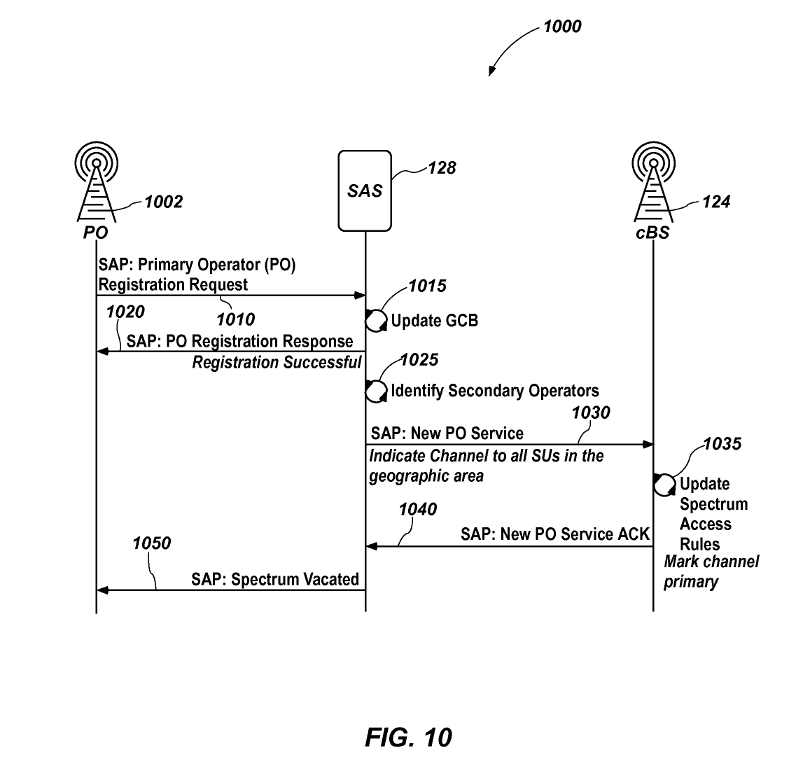

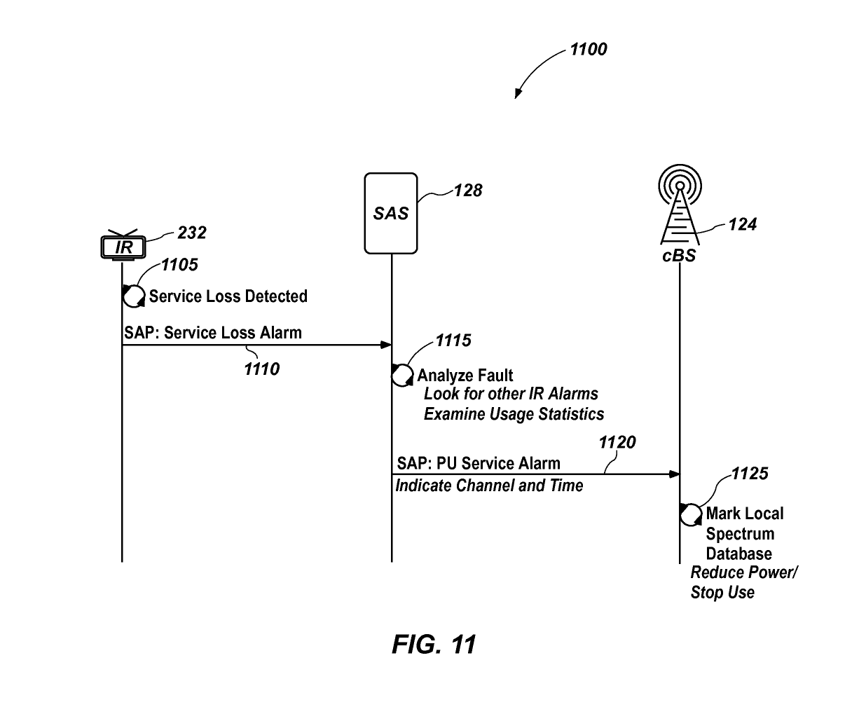

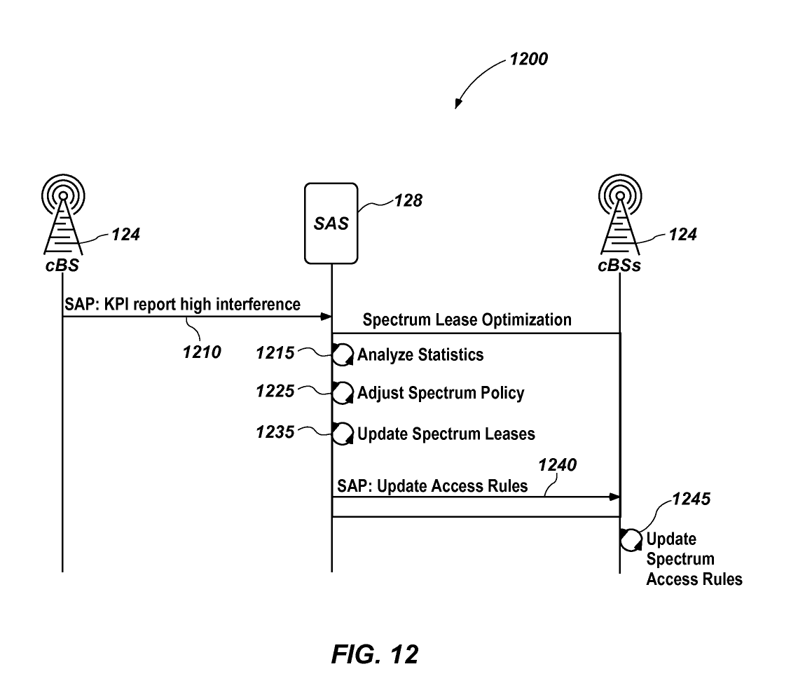

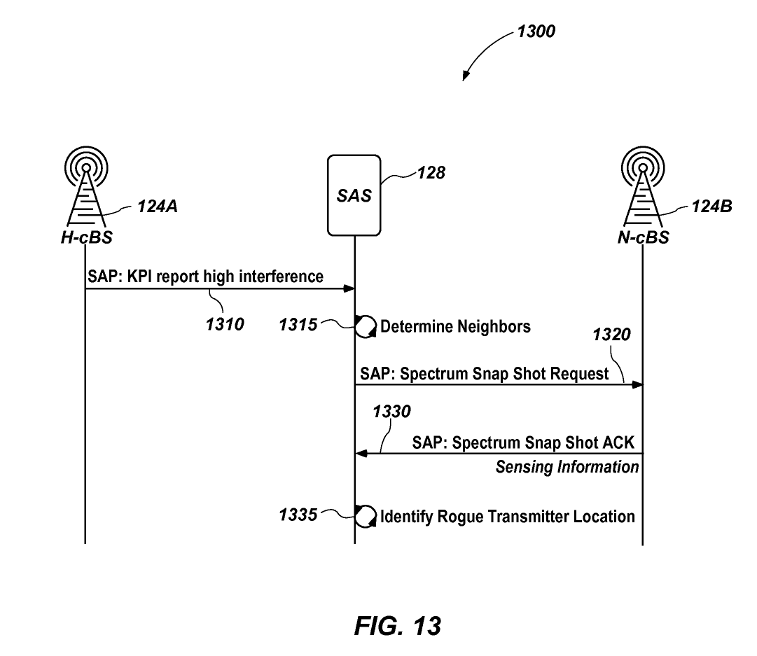

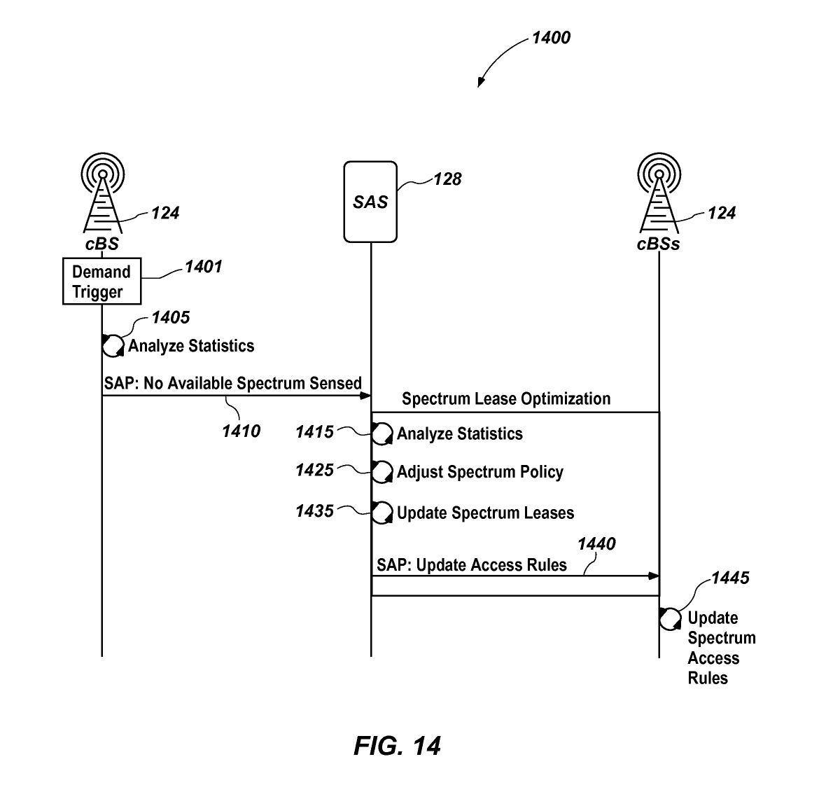

FIGS. 10-14 generally relate to spectrum lease management by the spectrum accountability server 128 and other network elements of the DSA overlay architecture. The spectrum lease management includes a framework and operational procedures for spectrum accountability of spectrum lease. Spectrum accountability and spectrum lease management may be concerned with monitoring spectrum usage metrics (e.g., KPI), and adjusting spectrum leases to handle problems with interference, performance issues, and spectrum access rule changes. Such spectrum management procedures may be employed through a variety of alarm and response procedures that may be used to dynamically adapt spectrum leases through the adjustment of spectrum access polices and rules. Such spectrum management procedures include new primary operator alerts (FIG. 10), integrated interference alarms (FIG. 11), high interference spectrum leases (FIG. 12), rogue transmitter detection (FIG. 13), and a spectrum unavailable alarm procedure (FIG. 14).

FIG. 10 is a simplified wireless communication system including a DSA and spectrum accountability framework. In particular, FIG. 10 shows the wireless communication system performing a new primary operator alert procedure 1000 according to an embodiment of the present disclosure. The new primary operator alert procedure 1000 may notify the cognitive base stations 124 of a new primary operator 1002. At operation 1010, the new primary operator 1002 transmits a registration request to the spectrum accountability server 128. The registration request includes registration information about the new primary operator 1002. The registration information may include information related to the new operator's licensed spectrum, such as, for example, the center frequency, the bandwidth, and the licensed geographic area for the licensed spectrum of the new primary operator 1002. At operation 1015, the spectrum accountability server 128 updates the geolocation database 130 (FIG. 1A) with the registration information. At operation 1020, the spectrum accountability server 128 returns a registration response. The registration response may indicate that the registration with the spectrum accountability server 128 was successful. At operation 1025, the spectrum accountability server 128 identifies the associated cognitive base stations 124 that may be affected as potential secondary operators of the new primary operator 1002. The spectrum accountability server 128 may identify the associated cognitive base stations 124 by searching through data stored in the geolocation database 130.

At operation 1030, the spectrum accountability server 128 notifies the cognitive base stations 124 that there is a new primary operator service on a specific spectrum channel. Notification may be performed by transmitting a new primary operator service notification signal to the affected cognitive base stations 124. At operation 1035, the cognitive base stations 124 update the spectrum access rules. For example, the cognitive base stations 124 may mark a particular set of frequency channels to belong to a primary operator, and the cognitive base stations 124 may vacate that particular set of frequency channels. At operation 1040, the cognitive base station 1040 transmits an acknowledgment signal to the spectrum accountability server 128 indicating that the cognitive base station 124 vacated the relevant set of frequency channels. Once all the affected cognitive base stations 124 have completed vacating the spectrum, the spectrum accountability server 128 may notify the primary operator 1002 by transmitting an appropriate spectrum vacated notification signal, at operation 1050.

FIG. 11 is a simplified wireless communication system including a DSA and spectrum accountability framework. In particular, FIG. 11 shows the wireless communication system performing an integrated receiver interference alarm procedure 1100 according to an embodiment of the present disclosure. One of the problems with using a DSA overlay is the problem of the hidden receiver, in which a primary operator transmits to a secondary receiver and unknowingly also interferes with a hidden primary receiver receiving transmission from the primary operator. The integrated receiver interference alarm procedure 1100 provides a method for reducing or avoiding interference to hidden receivers by employing the integrated receiver 232 to detect a loss of service and reporting the loss of service to the spectrum accountability server 128.

Each integrated receiver 232 may register with the spectrum accountability server 128 (e.g., via a network, such as the internet). The integrated receiver 232 may be configured to have knowledge of its own physical location, for example, by either a postal address provided by an end user or geolocation information provided by a global positioning system (GPS). Thus, the integrated receiver 232 may be configured to identify, locate, and couple with the spectrum accountability server 128 by a query to a server, similar to a DNS server, which resolves the proper regional spectrum accountability server 128.

At operation 1105, the integrated receiver 232 detects a service loss resulting from interference. At operation 1110, the integrated receiver (IR) transmits a service loss alarm signal to the spectrum accountability server 128. At operation 1115, the spectrum accountability server 128 analyzes the existing spectrum leases and related usage spectrum statistics to determine the potential interferers on the wireless network. At operation 1120, the spectrum accountability server 128 transmits a service alarm signal to the cognitive base station 124 that is determined to be interfering with the integrated receiver 232. At operation 1125, the cognitive base stations 124 update a local spectrum database (not shown) and adjust operating parameters for the secondary users employing the interfering spectrum leases. For example, the cognitive base stations 124 may reduce downlink power for a particular DSA carrier causing the interference, stop using the DSA carrier causing the interference, or take other remedial actions.

FIG. 12 is a simplified wireless communication system including a DSA and spectrum accountability framework. In particular, FIG. 12 shows the wireless communication system performing a high interference spectrum lease procedure 1200 according to an embodiment of the present disclosure. The high interference spectrum lease procedure 1200 may detect the spectrum leases that experience high amounts of interference and adjust the spectrum access policy to mitigate the problem, if possible. At operation 1210, the cognitive base station 124 detects and reports the existence of relatively high interference to the spectrum accountability server 128. For example, the cognitive base station 124 transmits data including spectrum usage metrics (e.g., KPI) to the spectrum accountability server 128, which data may indicate poor service or the inability to provide service using the spectrum lease.

During operations 1215, 1225, and 1235, the spectrum accountability server 128 analyzes the spectrum usage metrics and makes appropriate changes to the spectrum leases governed by the spectrum accountability server 128. For example, at operation 1215, the spectrum accountability server 128 analyzes statistics included in the spectrum usage metrics for the spectrum leases. At operation 1225, the spectrum accountability server 128 adjusts the spectrum access policy and spectrum access rules accordingly. At operation 1235, the spectrum accountability server 128 updates the set of spectrum leases according to the new spectrum access rules adjusted during operation 1235. At operation 1240, the spectrum accountability server 128 updates the spectrum access rules by transmitting the new spectrum access rules to the cognitive base stations 124 internal to the network that are affected by the changes. At operation 1245, the neighbor cognitive base stations 124 update their spectrum leases, DSA carriers, and the new spectrum access rules accordingly.

Another possible cause of relatively high interference (e.g., blocking, service loss, etc.) is the presence of a rogue transmitter on the wireless network. A rogue transmitter is a transmitter that uses spectrum channels without a spectrum license and without a spectrum lease. Therefore, in addition to reducing high interference by adjusting spectrum access rules through a policy change, the spectrum accountability server 128 may also search for rogue transmitters.

FIG. 13 is a simplified wireless communication system including a DSA and spectrum accountability framework. In particular, FIG. 13 shows the wireless communication system performing a rogue transmitter alarm procedure 1300 according to an embodiment of the present disclosure. At operation 1310, the first cognitive base station 124A of a first wireless network detects and reports the existence of relatively high interference to the spectrum accountability server 128. For example, the cognitive base station 124 transmits data including spectrum usage metrics (e.g., KPI) to the spectrum accountability server 128, which data may indicate poor service or the inability to provide service using the spectrum lease. At operation 1315, the spectrum accountability server 128 determines which neighbor cognitive base stations 124B of a second wireless network are in the geographic vicinity of the first cognitive base station 124A from which the interference report transmission occurred. At operation 1320, the spectrum accountability server 128 transmits a spectrum snapshot request signal to each neighbor cognitive base station 124B considered to be in the geographical area of interest. At operation 1330, each of the neighbor cognitive base stations 124B in the area replies by transmitting a spectrum snapshot acknowledgment signal 1330 including spectrum sensing information from each of the neighbor cognitive base stations 124B. At operation 1335, the spectrum accountability server 128 uses the spectrum sensing information from the first cognitive base station 124A and each neighbor cognitive base station 124B to determine the geolocation of the rogue transmitter. Determining the geolocation of the rogue transmitter may include performing techniques on the spectrum snapshot, such as triangulation, angle of arrival estimation methods, difference and time of arrival methods, among others. The determination of the rogue transmitter may be used by regulators to issue fines or take other appropriate measures.

FIG. 14 is a simplified wireless communication system including a DSA and spectrum accountability framework. In particular, FIG. 14 shows the wireless communication system performing a spectrum unavailable alarm procedure 1400 according to an embodiment of the present disclosure. In the spectrum unavailable alarm procedure 1400, a cognitive base station 124 of a wireless network detects that future demand will likely exceed its capacity. However, the cognitive base station 124 may be unable to issue a spectrum lease request given the existing rule set from the spectrum accountability server 128. As a result, the spectrum accountability server 128 may notify operators (e.g., regulators) of spectrum access policies that may be overly strict. The spectrum accountability server 128 may also notify operators about the lack of spectral resources. The spectrum accountability server 128 may gradually relax policy restrictions and observe interference alarms from integrated receivers (FIG. 2A) or other cognitive base stations 124.

At operation 1401, the cognitive base station 124 may identify a need for more spectrum based at least in part on a demand trigger. In response to the demand trigger, the cognitive base station 124 may calculate a spectrum lease request at operation 1405. While calculating the spectrum lease request, the cognitive base station may examine the spectrum information and existing spectrum access rule set, whereupon the cognitive base station 124 may determine that the needed additional spectrum for the spectrum lease may be either insufficient or unavailable. At operation 1410, the cognitive base station 124 transmits a spectrum unavailable alarm signal to the spectrum accountability server 128. During operations 1415, 1425, and 1435, the spectrum accountability server 128 analyzes the spectrum usage metrics and makes changes to the presently issued spectrum leases. For example, at operation 1415, the spectrum accountability server 128 analyzes statistics included within the spectrum usage metrics. At operation 1425, the spectrum accountability server 128 adjusts the spectrum access policy (i.e., spectrum access rules) accordingly. At operation 1435, the spectrum accountability server 128 updates the set of presently issued spectrum leases. At operation 1440, the spectrum accountability server 128 updates the spectrum access rules by transmitting the new spectrum access rules to the other cognitive base stations 124 of the same wireless network that may be affected by the changes to the spectrum access rules. At operation 1445, the other cognitive base stations 124 of the same wireless network update the spectrum access rules accordingly. The other cognitive base stations 124 of the same wireless network may then use the updated spectrum access rule sets when issuing future spectrum lease requests. As a result, the spectrum unavailable alarm procedure 1400 permits the spectrum accountability server 128 to examine the current spectrum usage metrics and related statistics along with the current spectrum access policy and determine whether the spectrum accountability server 128 is permitted to change the spectrum leases or adjust the spectrum access rules in order to increase the spectrum available.

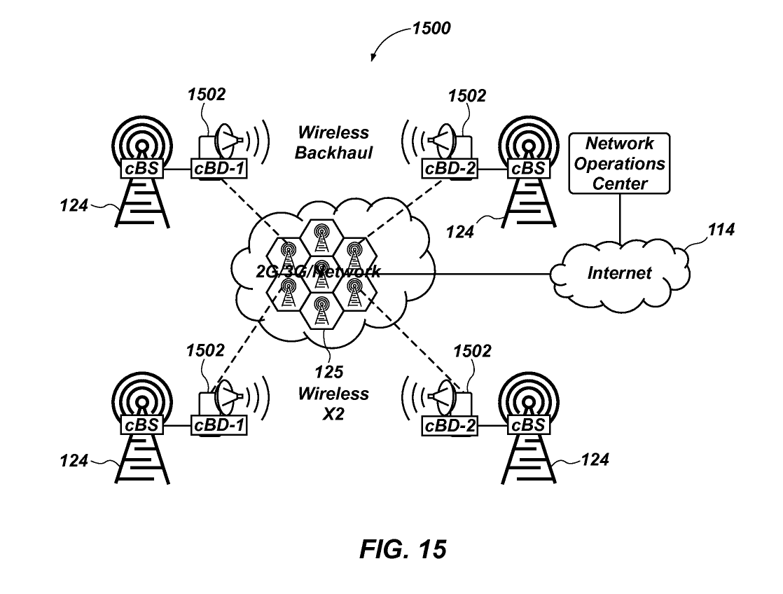

FIG. 15 is a wireless network 1500 according to an embodiment of the present disclosure. The wireless network 1500 may be include cognitive base stations 124 that operate within a spectrum accountability and DSA framework as previously discussed above. The wireless network 1500 may further include cognitive backhaul devices 1502. Each cognitive backhaul device 1502 may be associated with one of the cognitive base stations 124. The cognitive backhaul devices 1502 may communicate with each other as a point-to-point link, and be configured to provide connectivity for the cognitive base stations 124 to communicate with the first network. The cognitive backhaul devices 1502 may communicate with each other over primary carriers of the licensed network for the cognitive base stations 124. The cognitive backhaul devices 1502 may further be configured to operate as secondary users using DSA carriers as provided by a spectrum lease to the cognitive base stations 124. The spectrum lease may be issued and monitored as previously discussed above.

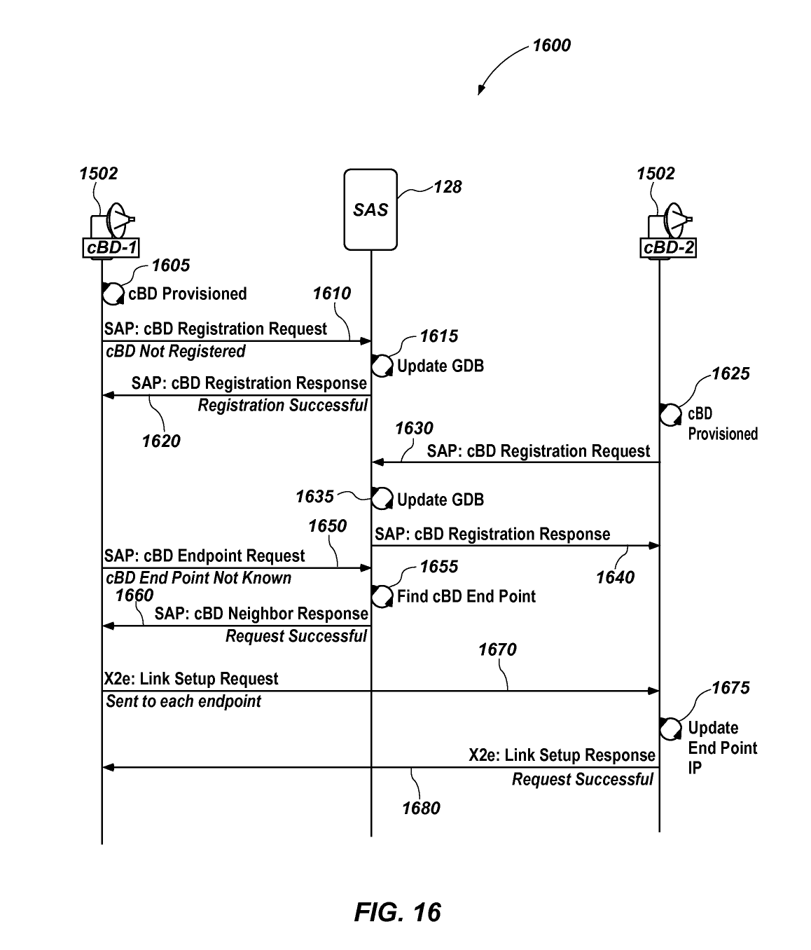

FIG. 16 is a simplified wireless communication system including a DSA and spectrum accountability framework. In particular, FIG. 16 shows the wireless communication system performing a cognitive backhaul device registration procedure 1600 according to an embodiment of the present disclosure. For example, a first cognitive backhaul device (cBD-1) 1502 and a second cognitive backhaul device (cBD-2) 1502 may each register with the spectrum accountability server 128 so as to be able to communicate with each other over DSA carriers through a spectrum lease.

At operation 1605, the first cognitive backhaul device (cBD-1) 1502 is provisioned. The first cognitive backhaul device (cBD-1) 1502 may have a connection to an IP network (e.g., internet) such that the first cognitive backhaul device (cBD-1) 1502 may know of the spectrum accountability server 128. At operation 1610, the first cognitive backhaul device (cBD-1) 1502 sends a registration request to the spectrum accountability server 128. At operation 1615, the spectrum accountability server 128 updates the information from the first cognitive backhaul device (cBD-1) 1502 into the geolocation database. At operation 1620, the spectrum accountability server 128 sends a registration response confirming that registration of the first cognitive backhaul device (cBD-1) 1502 is successful.

The second cognitive backhaul device (cBD-2) 1502 may also register with the spectrum accountability server 128 in a similar manner. At operation 1625, the second cognitive backhaul device (cBD-2) 1502 is provisioned. At operation 1630, the second cognitive backhaul device (cBD-2) 1502 sends a registration request to the spectrum accountability server 128. At operation 1635, the spectrum accountability server 128 updates the information from the second cognitive backhaul device (cBD-2) 1502 into the geolocation database. At operation 1640, the spectrum accountability server 128 sends a registration response confirming that registration of the second cognitive backhaul device (cBD-2) 1502 is successful.

At operation 1650, the first cognitive backhaul device (cBD-1) 1502 may desire to know of an end point, and send an endpoint request to the spectrum accountability server 128. At operation 1655, the spectrum accountability server 128 may find the end point, such as by querying the geolocation database for information regarding registered cognitive backhaul devices. At operation 1660, the spectrum accountability server 128 may send a neighbor response to the first cognitive backhaul device (cBD-1) 1502 confirming that the neighbor request is successful. The neighbor request may include the end point data (physical location, IP address, etc.) for the second cognitive backhaul device (cBD-2) 1502 and for other cognitive backhaul devices 1502 of interest.

At operation 1670, the first cognitive backhaul device (cBD-1) 1502 may send a link set up request to the second cognitive backhaul device (cBD-2) 1502 (and other end points of interest) so that each end point cognitive backhaul device 1502 may be aware of the first cognitive backhaul device (cBD-1) 1502. At operation 1675, the second cognitive backhaul device (cBD-2) 1502 may update the end point IP address for the first cognitive backhaul device (cBD-2) 1502. At operation 1680, the second cognitive backhaul device (cBD-2) 1502 may send a link setup response to the first cognitive backhaul device (cBD-2) 1502 confirming that the link set up request is successful, and that a link has been established between the first cognitive backhaul device (cBD-2) 1502 and the second cognitive backhaul device (cBD-2) 1502 (and other end points).

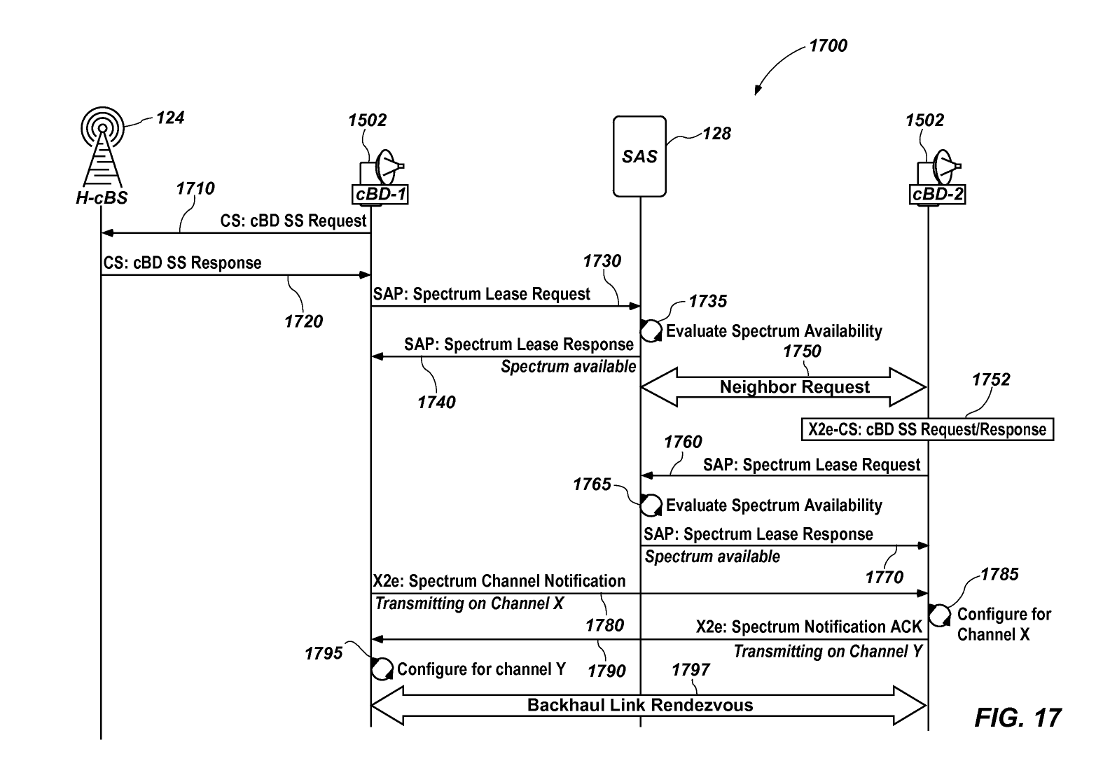

FIG. 17 is a simplified wireless communication system including a DSA and spectrum accountability framework. In particular, FIG. 17 shows the wireless communication system performing a cognitive backhaul device spectrum lease procedure 1700 according to an embodiment of the present disclosure. In some situations, it may be desirable for cognitive backhaul devices 1502 to use DSA carriers as secondary users of a network. As a result, cognitive backhaul devices 1502 may be configured to request and obtain spectrum leases to communicate with each other. The spectrum lease requests may be calculated from spectrum snapshot data. The cognitive backhaul device spectrum lease procedure 1700 shows two contemplated methods for the cognitive backhaul devices 1502 to obtain the spectrum snapshot data. For example, the first cognitive backhaul device (cBD-1) 1502 may obtain spectrum snapshot data from a cognitive base station 124 within its network, and the second cognitive backhaul device (cBD-2) 1502 may obtain spectrum snapshot data from a cognitive base station 124 within its neighboring network. Additional methods for obtaining a spectrum snapshot may be used.

At operation 1710, the first cognitive backhaul device (cBD-1) 1502 may send a spectrum snapshot request to a cognitive base station 124 within its network. At operation 1720, the cognitive base station 124 sends a spectrum snapshot response including the spectrum snapshot information maintained by the cognitive base station 124. At operation 1730, the first cognitive backhaul device (cBD-1) 1502 may send a spectrum lease request to the spectrum accountability server 128. At operation 1735, the spectrum accountability server 128 evaluates the availability of the spectrum requested. At operation 1740, a spectrum lease response is sent to the first cognitive backhaul device (cBD-1) 1502 indicating that the spectrum for the spectrum lease is available.

A second method for obtaining spectrum snapshot data may be to obtain the spectrum snapshot from a cognitive base station 124 outside of its network. At operation 1750, the second cognitive backhaul device (cBD-2) 1502 may obtain neighbor information from the spectrum accountability server 128. For example, the second cognitive backhaul device (cBD-2) 1502 may send a neighbor request, and the spectrum accountability may send a response with the neighbor information of interest. At operation 1752, the second cognitive backhaul device (cBD-2) 1502 may obtain the spectrum snapshot data from a cognitive base station 124 of the neighboring network. For example, the second cognitive backhaul device (cBD-2) 1502 may send a spectrum snapshot request to a neighbor cognitive base station 124, and the neighbor cognitive base station 124 may respond with the spectrum snapshot data maintained by the neighbor cognitive base station 124. At operation 1760, the second cognitive backhaul device (cBD-2) 1502 may send a spectrum lease request. At operation 1765, the spectrum accountability server 128 evaluates the availability of the spectrum requested. At operation 1770, a spectrum lease response is sent to the second cognitive backhaul device (cBD-2) 1502 indicating that the spectrum for the spectrum lease is available.

At this point, both the first cognitive backhaul device (cBD-1) 1502 and the second cognitive backhaul device (cBD-2) 1502 may have spectrum leases, and may use DSA carriers to communicate. It may not, however, be known which channels of the DSA carriers each of the first cognitive backhaul device (cBD-1) 1502 and the second cognitive backhaul device (cBD-2) 1502 are using for the spectrum lease. At operation 1780, the first cognitive backhaul device (cBD-1) 1502 may send a spectrum channel notification to the second cognitive backhaul device (cBD-2) 1502 indicating that the first cognitive backhaul device (cBD-1) 1502 will be transmitting on channel X during its spectrum lease. The spectrum channel notification may be sent over an IP network. At operation 1785, the second cognitive backhaul device (cBD-2) 1502 may configure its receiver to receive data from the first cognitive backhaul device (cBD-1) 1502 over channel X. At operation 1790, the second cognitive backhaul device (cBD-2) 1502 may send a spectrum channel notification to the first cognitive backhaul device (cBD-1) 1502 indicating that the second cognitive backhaul device (cBD-2) 1502 will be transmitting on channel Y during its spectrum lease. The spectrum channel notification may be sent over an IP network. At operation 1795, the first cognitive backhaul device (cBD-1) 1502 may configure its receiver to receive data from the second cognitive backhaul device (cBD-2) 1502 over channel Y. At this point, the first cognitive backhaul device (cBD-1) 1502 and the second cognitive backhaul device (cBD-2) 1502 may be configured to communicate with each other during their respective spectrum leases, and a backhaul link rendezvous 1797 may be established.

### CONCLUSION

In one embodiment, a wireless communication system includes at least one cognitive base station configured to communicate over at least one licensed carrier, and a spectrum accountability server operably coupled to the at least one cognitive base station. The spectrum accountability server is configured to manage spectrum leases to dynamic spectrum access carriers according to a set of spectrum access rules.

In another embodiment, a spectrum accountability server for a wireless network is disclosed. The spectrum accountability server is configured to receive a spectrum lease request from a first cognitive base station of a first network, issue a spectrum lease to the first cognitive base station to operate on a dynamic spectrum access carrier outside of the first network, and receive spectrum usage data from the first cognitive base station for spectrum usage during the spectrum lease.

In another embodiment, a cognitive base station for a wireless network is disclosed. The cognitive base station is configured to communicate with user equipment over at least one carrier of a first network, communicate with user equipment over at least one among dynamic spectrum access carriers outside of the first network within terms of a spectrum lease issued by a spectrum accountability server, and report spectrum usage metrics to the spectrum accountability server indicating spectrum use of the cognitive base station during the spectrum lease.

In another embodiment, a method for providing dynamic spectrum access to at least one secondary user of a wireless network is disclosed. The method comprises receiving a spectrum lease request for at least one secondary user to operate in spectrum to which the at least one secondary user does not have a spectrum license, evaluating the spectrum lease request based at least in part on spectrum access rules, permitting the spectrum lease request and issuing a spectrum lease when parameters of the spectrum lease request are within the spectrum access rules, and denying the spectrum lease request when the requested spectrum is not available.

In another embodiment, a method of adjusting spectrum access rules that determine at least one among lease requests of secondary users of a wireless network is disclosed. The method comprises receiving an alarm from at least one of a primary operator and a secondary user, evaluating a cause of the alarm, and adjusting spectrum access rules in response to the cause of the alarm.

While the disclosure is susceptible to various modifications and implementation in alternative forms, specific embodiments have been shown by way of non-limiting examples in the drawings and have been described in detail herein. It should be understood that the invention is not intended to be limited to the particular forms disclosed. Rather, the invention includes all modifications, equivalents, and alternatives falling within the scope of the following claims and their legal equivalents.

What is claimed is:

1. A wireless communication system, comprising:
at least one cognitive base station configured to communicate over at least one licensed carrier; and
a spectrum accountability server operably coupled to the at least one cognitive base station, wherein the spectrum accountability server is configured to manage spectrum leases to dynamic spectrum access carriers according to a set of spectrum access rules.

2. The wireless communication system of claim 1, wherein the at least one cognitive base station is configured to communicate over the dynamic spectrum access carriers during a spectrum lease.

3. The wireless communication system of claim 1, wherein the at least one cognitive base station is configured to report spectrum usage metrics from the spectrum lease to the spectrum accountability server.

4. The wireless communication system of claim 3, wherein the spectrum accountability server is configured to report the spectrum usage metrics to at least one of a network operator and a regulating agency.

5. The wireless communication system of claim 2, wherein the at least one cognitive base station is further configured to sub-lease the spectrum lease to another cognitive base station of another network.

6. The wireless communication system of claim 1, further including an integrated receiver configured to send an interference alarm to the spectrum accountability server in response to detection of interference from the at least one cognitive base station operating under a spectrum lease.

7. The wireless communication system of claim 1, wherein the spectrum accountability server is further configured to send neighbor data to the at least one cognitive base station, wherein the neighbor data includes information related to another cognitive base station of another network.

8. The wireless communication system of claim 7, wherein the at least one cognitive base station is further configured to communicate with the another cognitive base station of the another network.

9. The wireless communication system of claim 8, wherein the at least one cognitive base station is configured to perform at least one of cooperative spectrum sensing and spectrum trading with the another cognitive base station of the another network.

10. The wireless communication system of claim 1, wherein the at least one cognitive base station is configured to calculate a spectrum lease request based, at least in part, on a spectrum snapshot.

11. The wireless communication system of claim 1, wherein the spectrum accountability server evaluates and issues spectrum leases as an overlay to an existing wireless communication network.

12. The wireless communication system of claim 1, wherein the existing wireless communication network is selected from the group consisting of a Long-Term Evolution (LTE) network and a Worldwide Interoperability for Microwave Access (WiMax) network.

13. The wireless communication system of claim 1, wherein the spectrum accountability server is further configured to dynamically change the spectrum access rules in response to reported conditions of the spectrum leases.

14. A spectrum accountability server for a wireless network, the spectrum accountability server configured to:
receive a spectrum lease request from a first cognitive base station of a first network; and
issue a spectrum lease to the first cognitive base station to operate on a dynamic spectrum access carrier outside of the first network.

15. The spectrum accountability server of claim 14, further configured to receive spectrum usage data from the first cognitive base station for spectrum usage during the spectrum lease.

16. The spectrum accountability server of claim 14, wherein the spectrum accountability server is further configured to maintain a geolocation database including information from the cognitive base station of the first network and at least one cognitive base station of at least one second network.

17. The spectrum accountability server of claim 16, wherein the information in the geolocation database includes at least one of a physical geographical location and an IP address of at least one among the cognitive base stations of the first network and the at least one second network.

18. The spectrum accountability server of claim 14, wherein the spectrum accountability server is further configured to dynamically change spectrum access policies that govern issuing the spectrum lease in response to the spectrum usage data.

19. The spectrum accountability server of claim 14, wherein the spectrum accountability server is further configured to register a new primary operator and notify at least one secondary operator of the new primary operator.

20. The spectrum accountability server of claim 14, wherein the spectrum accountability server is further configured to identify a location of a rogue transmitter based on spectrum snapshot information received from at least one cognitive base station being at least one of within the first network and outside the first network.

21. The spectrum accountability server of claim 20, wherein the spectrum snapshot information is combined with spectrum sense information from the cognitive base stations and user equipment outside of the first network.

22. A cognitive base station for a wireless network, the cognitive base station configured to:
communicate with user equipment over at least one carrier of a first network;
communicate with user equipment over at least one among dynamic spectrum access carriers outside of the first network within terms of a spectrum lease issued by a spectrum accountability server; and
report spectrum usage metrics to the spectrum accountability server indicating spectrum use of the cognitive base station during the spectrum lease.

23. The cognitive base station of claim 22, wherein the at least one among dynamic spectrum access carriers outside of the first network is licensed to another network operator.

24. The cognitive base station of claim 22, wherein the cognitive base station is further configured to communicate with at least one cognitive base station of a different wireless network.

25. The cognitive base station of claim 22, wherein overflow service is placed on dynamic spectrum access carriers during the spectrum lease.

26. The cognitive base station of claim 25, wherein the cognitive base station is further configured to coordinate a handoff from a connected user equipment from communicating over a carrier of the first network to a dynamic spectrum access carrier based on a priority setting of the connected user equipment.

27. A method for providing dynamic spectrum access to at least one secondary user of a wireless network, the method comprising:
receiving a spectrum lease request for at least one secondary user to operate in a spectrum to which the at least one secondary user does not have a spectrum license;
evaluating the spectrum lease request based at least in part on spectrum access rules;
permitting the spectrum lease request and issuing a spectrum lease when parameters of the spectrum lease request are within the spectrum access rules; and
denying the spectrum lease request when the requested spectrum of the spectrum lease request is not available.

28. The method of claim 27, wherein the spectrum lease is issued to a cognitive backhaul device when the parameters of the spectrum lease request are within the spectrum access rules.

29. The method of claim 27, wherein a basis for denying the spectrum lease request when the requested spectrum of the spectrum lease request is not available includes the parameters of the spectrum lease request not being within the spectrum access rules.

30. A method of adjusting spectrum access rules that determine at least one among lease requests of secondary users of a wireless network, the method comprising:
receiving an alarm from at least one of a primary operator and a secondary user;
evaluating a cause of the alarm; and
adjusting spectrum access rules in response to the cause of the alarm.
